(19) United States
(12) Patent Application Publication
(10) Pub. No.: US 2026/0017874 A1
(43) Pub. Date: Jan. 15, 2026

(54) INFORMATION PROCESSING SYSTEM, OPERATION METHOD OF INFORMATION PROCESSING SYSTEM, AND PROGRAM

(71) Applicant: Sony Group Corporation, Tokyo (JP)

(72) Inventor: Kendai FURUKAWA, Tokyo (JP)

(73) Assignee: Sony Group Corporation, Tokyo (JP)

(21) Appl. No.: 18/994,621

(22) PCT Filed: Jul. 21, 2023
(86) PCT No.: PCT/JP2023/026798

§ 371 Date: Jan. 15, 2025

(30) Foreign Application Priority Data
Aug. 4, 2022 (JP) 2022-124543

(51) Int. Cl. G06T 15/20; G06T 7/90

(52) U.S. Cl. CPC G06T 15/20; G06T 7/90

(57) ABSTRACT

There is provided an information processing system capable of easily correcting a failure occurring in a virtual viewpoint image (free viewpoint image, volumetric image), an operation method of the information processing system, and a program. A virtual viewpoint image is generated by synthesizing on the basis of a color synthesis weight set for each of multi-viewpoint images, an input of a failure region of the virtual viewpoint image is received, a correction input of a color synthesis weight of the failure region of each of the multi-viewpoint images used for synthesis is received, the color synthesis weight is corrected to a plurality of the color synthesis weights based on the correction input, a plurality of the virtual viewpoint images is re-synthesized as a correction candidate image on the basis of the plurality of color synthesis weights, the color synthesis weights applied in a correction candidate image selected from a plurality of the correction candidate images as the failure is regarded as being corrected are determined as correction information for correcting the failure. The present disclosure can be applied to a generation device of a volumetric image.

### TECHNICAL FIELD

The present disclosure relates to an information processing system, an operation method of the information processing system, and a program, and more particularly, to an information processing system capable of easily correcting a failure occurring in a virtual viewpoint image (free viewpoint image, volumetric image), an operation method of the information processing system, and a program.

### BACKGROUND ART

There has been proposed a technique for generating a virtual viewpoint (free viewpoint, volumetric) image by synthesizing images captured using a large number of cameras.

Meanwhile, when a volumetric image (virtual viewpoint image) is generated, a failure may occur in the generated image. It is known that there are various types of failures that occur at the time of generating this volumetric image (virtual viewpoint image) depending on algorithms, camera configurations, viewpoint positions, and the like.

Therefore, a technique of suppressing a failure that is likely to occur according to an algorithm used in generation of a volumetric image (virtual viewpoint image) and a type such as a camera configuration and a viewpoint position has been proposed (see Patent Document 1).

Furthermore, conventionally, failure correction has been manually performed by retouch, but correction work is complicated, and in order to realize sufficient correction work, a skilled technique is required for correction work itself.

Therefore, a technique has been proposed in which a type of a failure occurring in a two-dimensional image and a correction case by a skilled person for a corresponding failure are accumulated, and the corresponding correction case is applied according to the occurred failure, thereby facilitating correction (see Patent Document 2).

### CITATION LIST

### Patent Document

Patent Document 1: Japanese Patent Application Laid-Open No. 2017-211827
Patent Document 2: Japanese Patent Application Laid-Open No. 2020-64671

### SUMMARY OF THE INVENTION

### Problems to be Solved by the Invention

However, the technique of Patent Document 1 can suppress a failure that is likely to occur in a process of generating a volumetric image (virtual viewpoint image), but cannot correct a failure that occurs in the generated volumetric image.

Furthermore, since the technique of Patent Document 2 does not support moving images, for example, it is necessary to individually correct failures in two-dimensional images continuous in time series one by one, and correction work becomes a heavy burden.

Moreover, it is necessary to repeat inefficient correction work similar to the conventional work until the type of the occurred failure and the corresponding correction cases of the skilled person are sufficiently accumulated.

The present disclosure has been made in view of such a situation, and in particular, enables easy correction of a failure occurring in a virtual viewpoint image (free viewpoint image, volumetric image).

### Solutions to Problems

An information processing system and a program according to one aspect of the present disclosure are an information processing system including: a virtual viewpoint image generation unit that generates a virtual viewpoint image by synthesizing multi-viewpoint images on the basis of a color synthesis weight set for each of the multi-viewpoint images according to a virtual viewpoint position; a failure region acquisition unit that receives an input of a failure region designated by a user as a region in which a failure occurs in the virtual viewpoint image; a re-synthesis unit that receives a correction input of the color synthesis weight of the failure region in each of the multi-viewpoint images used for synthesis of the virtual viewpoint image, corrects the color synthesis weight to a plurality of the color synthesis weights based on the correction input, and re-synthesizes a plurality of the virtual viewpoint images as a correction candidate image on the basis of the plurality of color synthesis weights; and a correction information determination unit that receives selection information of the correction candidate image selected from a plurality of the correction candidate images as the failure is regarded as being corrected, and on the basis of the selection information, determines the color synthesis weights applied to the selected correction candidate image as correction information for correcting the failure, and a program.

An operation method of an information processing system according to one aspect of the present disclosure is an operation method of an information processing system, the operation method including the steps of: generating a virtual viewpoint image by synthesizing multi-viewpoint images on the basis of a color synthesis weight set for each of the multi-viewpoint images according to a virtual viewpoint position; receiving an input of a failure region designated by a user as a region in which a failure occurs in the virtual viewpoint image; receiving a correction input of the color synthesis weight of the failure region in each of the multi-viewpoint images used for synthesis of the virtual viewpoint image, correcting the color synthesis weight to a plurality of the color synthesis weights based on the correction input, and re-synthesizing a plurality of the virtual viewpoint images as a correction candidate image on the basis of the plurality of color synthesis weights; and receiving selection information of the correction candidate image selected from a plurality of the correction candidate images as the failure is regarded as being corrected, and on the basis of the selection information, determining the color synthesis weights applied to the selected correction candidate image as correction information for correcting the failure.

According to one aspect of the present disclosure, a virtual viewpoint image is generated by synthesizing multi-viewpoint images on the basis of a color synthesis weight set for each of the multi-viewpoint images according to a virtual viewpoint position, an input of a failure region designated by a user as a region in which a failure occurs is received in the virtual viewpoint image, a correction input of the color synthesis weight of the failure region in each of the multi-viewpoint images used for synthesis of the virtual viewpoint image is received, the color synthesis weight is corrected to a plurality of the color synthesis weights based on the correction input, a plurality of the virtual viewpoint images is re-synthesized as a correction candidate image on the basis of the plurality of color synthesis weights, selection information of the correction candidate image selected from a plurality of the correction candidate images as the failure is regarded as being corrected is received, and on the basis of the selection information, the color synthesis weights applied to the selected correction candidate image is determined as correction information for correcting the failure.

### BRIEF DESCRIPTION OF DRAWINGS

FIG. 1 is a diagram explaining a configuration example of an image processing system that generates a volumetric image.

FIG. 2 is a diagram explaining a process of generating a volumetric image.

FIG. 3 is a diagram explaining viewpoint independent and viewpoint dependent vertex-based rendering.

FIG. 4 is a diagram explaining rendering based on a viewpoint dependent image.

FIG. 5 is a diagram explaining an example of a first failure in a virtual viewpoint image.

FIG. 6 is a diagram explaining an example of a second failure in a virtual viewpoint image.

FIG. 7 is a diagram explaining an example of a third failure in a virtual viewpoint image.

FIG. 8 is a diagram explaining a correction method of a failure region occurring in a virtual viewpoint image.

FIG. 9 is a diagram explaining a display example of a UI image for designating a failure region occurring in a virtual viewpoint image of the present disclosure.

FIG. 10 is a diagram explaining a display example of a UI image for correcting a color synthesis weight of a failure region occurring in a virtual viewpoint image of the present disclosure.

FIG. 11 is a diagram explaining an example of candidate images of a plurality of virtual viewpoint images generated in accordance with correction of color synthesis weights.

FIG. 12 is a diagram explaining an example of applying correction information of a first failure to consecutive frames.

FIG. 13 is a diagram explaining an example of applying correction information of a second failure to consecutive frames.

FIG. 14 is a diagram explaining an example of applying correction information of a third failure to consecutive frames.

FIG. 15 is a diagram explaining another display example of the UI image for correcting a color synthesis weight of a failure region occurring in a virtual viewpoint image of the present disclosure.

FIG. 16 is a diagram explaining an outline of an information processing system to which the technology of the present disclosure is applied.

FIG. 17 is a diagram explaining generation of a multi-viewpoint imaging system used to generate a virtual viewpoint image in an information processing system to which the technology of the present disclosure is applied.

FIG. 18 is a flowchart explaining a virtual viewpoint image display process by the information processing system in FIG. 16.

FIG. 19 is a diagram explaining a detailed configuration example of a rendering unit in FIG. 16.

FIG. 20 is a diagram explaining a detailed configuration example of a three-dimensional image synthesis unit in FIG. 17.

FIG. 21 is a diagram explaining a detailed configuration example of a three-dimensional image correction unit in FIG. 17.

FIG. 22 is a flowchart explaining rendering processing by the rendering unit in FIG. 19.

FIG. 23 is a flowchart explaining correction processing by a three-dimensional image correction unit in FIG. 21.

FIG. 24 is a diagram explaining a modification of the rendering unit in FIG. 16 and a configuration example of a correction case learning unit.

FIG. 25 is a diagram explaining a detailed configuration example of a three-dimensional image synthesis unit in FIG. 24.

FIG. 26 is a diagram explaining a detailed configuration example of a three-dimensional image correction unit in FIG. 24.

FIG. 27 is a flowchart explaining rendering processing by the rendering unit in FIG. 24.

FIG. 28 is a flowchart explaining correction processing by a three-dimensional image correction unit in FIG. 26.

FIG. 29 is a flowchart explaining learning processing by a correction case learning unit in FIG. 24.

FIG. 30 illustrates a configuration example of a general-purpose computer.

### MODE FOR CARRYING OUT THE INVENTION

Hereinafter, preferred embodiments of the present disclosure will be described in detail with reference to the accompanying drawings. Note that, in the present specification and drawings, configuration elements having substantially the same functional configuration are denoted by the same reference signs, and redundant description is omitted.

Hereinafter, modes for carrying out the technology of the present disclosure will be described. The description will be given in the following order.
1. Outline of present disclosure
2. Preferred embodiment
3. Modifications
4. Example of execution by software
5. Application example

### 1. Outline of Present Disclosure

### <Generation of Virtual Viewpoint Image>

In particular, the present disclosure enables easy correction of a failure occurring in a virtual viewpoint image (volumetric image, free viewpoint image).

Therefore, in describing the technology of the present disclosure, a configuration for generating a virtual viewpoint image and a generation process will be briefly described.

Generation of the virtual viewpoint image requires an image obtained by capturing an object from a plurality of viewpoint positions.

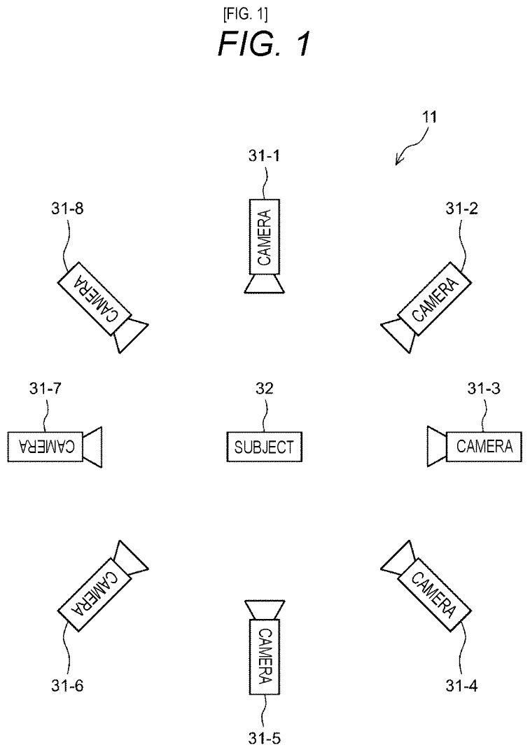

Therefore, in generating the virtual viewpoint image, an information processing system as illustrated in FIG. 1 is used.

An information processing system 11 in FIG. 1 is provided with a plurality of cameras 31-1 to 31-8 that can capture images of a subject 32 from many viewpoint positions.

Note that although FIG. 1 illustrates an example in which the number of cameras 31 is 8, a plurality of other cameras may be used. Furthermore, FIG. 1 illustrates an example in which the cameras 31-1 to 31-8 at eight viewpoint positions are provided so as to two-dimensionally surround the subject 32, but more cameras 31 may be provided so as to three-dimensionally surround the subject.

Hereinafter, in a case where it is not necessary to particularly distinguish the cameras 31-1 to 31-8, they are simply referred to as the camera 31, and the other configurations are also referred to similarly.

The cameras 31-1 to 31-8 capture images from a plurality of different viewpoint positions with respect to the subject 32.

Note that, hereinafter, images from a plurality of different viewpoint positions of the subject 32 captured by the plurality of cameras 31 are also collectively referred to as multi-viewpoint images.

The virtual viewpoint image is generated by rendering at the virtual viewpoint position from the multi-viewpoint images captured by the information processing system 11 in FIG. 1. In generating the virtual viewpoint image, three-dimensional data of the subject 32 is generated from the multi-viewpoint images, and a virtual viewpoint image (rendered image) is generated by rendering processing of the subject 32 at the virtual viewpoint position on the basis of the generated three-dimensional data.

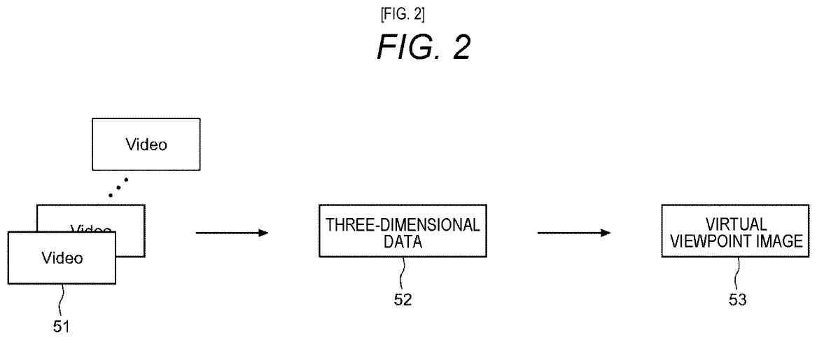

That is, as illustrated in FIG. 2, three-dimensional data 52 of the subject 32 is generated on the basis of multi-viewpoint images 51 of the subject 32.

Then, the rendering processing at the virtual viewpoint position is performed on the basis of the three-dimensional data 52 of the subject 32, and a virtual viewpoint image 53 is generated.

### <Rendering>

Next, rendering for generating the virtual viewpoint image 53 at the virtual viewpoint position will be described by taking as an example a case where color is applied on the basis of a predetermined vertex in the subject 32.

Rendering includes viewpoint independent (View Independent) that does not depend on a viewpoint and viewpoint dependent (View Dependent) that depends on a viewpoint position.

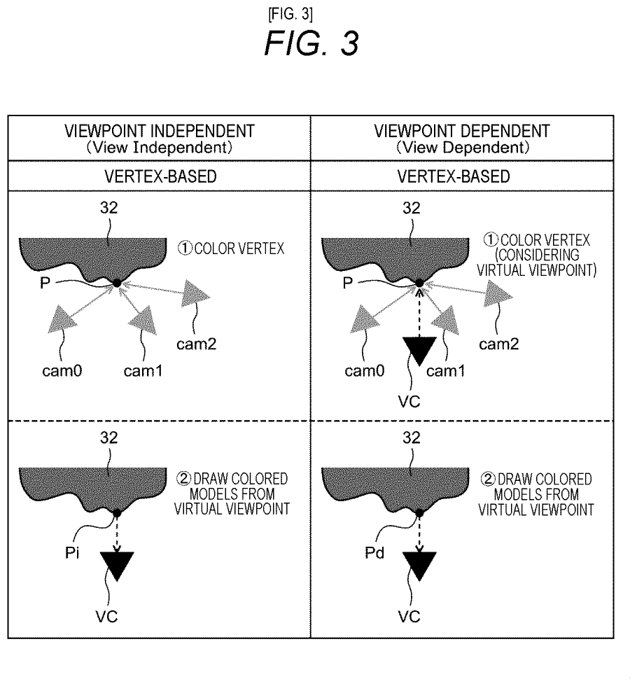

In a case where color is applied to the vertex P on the subject 32 from the virtual viewpoint position by viewpoint independent (View Independent) rendering on the basis of the multi-viewpoint images of the viewpoint positions cam0 to cam2 of the subject 32, the color is applied as illustrated in the left part of FIG. 3.

That is, as illustrated in the upper left part of FIG. 3, the pixel values corresponding to the vertexes P of the multi-viewpoint images of the viewpoint positions cam0 to cam2 are synthesized in consideration of the angle formed by the line-of-sight direction with respect to the vertexes P at the respective viewpoint positions cam0 to cam2 and the normal direction at the vertexes P, and are set as the pixel values Pi viewed from the virtual viewpoint VC as illustrated in the lower left part of FIG. 3.

On the other hand, in a case where color is applied to the vertex P on the subject 32 from the virtual viewpoint position by viewpoint dependent (View Dependent) rendering on the basis of the multi-viewpoint images of the viewpoint positions cam0 to cam2 of the subject 32, the color is applied as illustrated in the right part of FIG. 3.

That is, as illustrated in the upper right part of FIG. 3, the pixel values corresponding to the vertexes P of the multi-viewpoint images of the viewpoint positions cam0 to cam2 are synthesized in consideration of the angle formed by the line-of-sight direction from the virtual viewpoint VC and the normal direction of the vertex P in addition to the information of the angle formed by the line-of-sight direction with respect to the vertexes P of the viewpoint positions cam0 to cam2 and the normal direction at the vertexes P, and are set as the pixel values Pd viewed from the virtual viewpoint VC as illustrated in the lower right part of FIG. 3.

As illustrated in FIG. 3, in viewpoint dependent (View Dependent) rendering, when color is applied to the vertex P in viewpoint independent (View Independent) rendering, the angle formed by the line-of-sight direction from the virtual viewpoint and the normal direction at the vertex P is applied in consideration, so that a more natural color can be applied.

Therefore, in the present disclosure, it is assumed that viewpoint dependent (View Dependent) rendering is performed.

### <Viewpoint Dependent (View Dependent) Rendering>

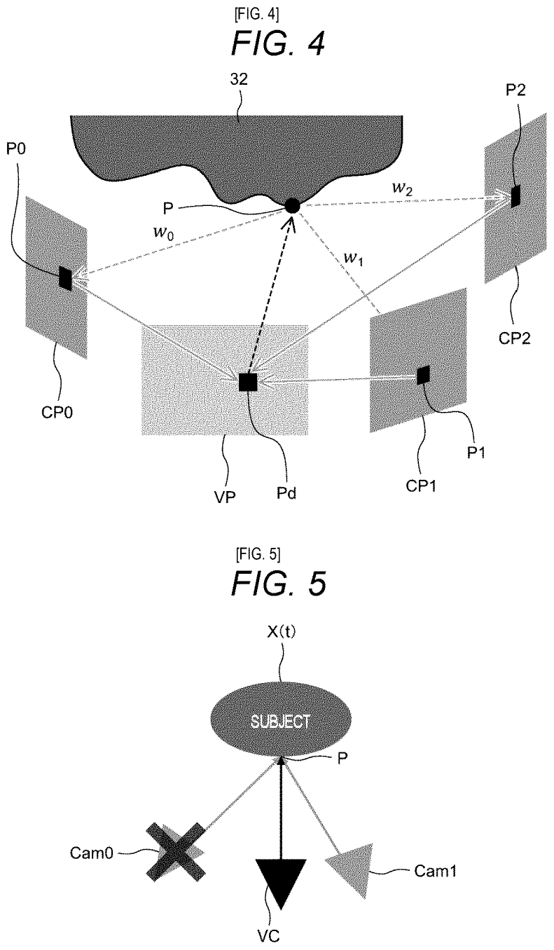

Here, with reference to FIG. 4, a case where color is applied on the basis of an image in viewpoint dependent (View Dependent) rendering will be further described.

In FIG. 4, the viewpoint dependent (View Dependent) rendering will be described assuming that pixels corresponding to the vertices P in the respective images CP0 to CP2 among the multi-viewpoint images captured by the viewpoint positions cam0 to cam2 are pixels P0 to P2, and pixels corresponding to the vertices P on the virtual viewpoint image VP at the virtual viewpoint position VC synthesized by the rendering are pixels Pd.

In this case, the color synthesis weights W0, W1, and W2 are set to the pixel values VP0 to VP2 of the pixels P0 to P2, respectively, on the basis of the angle formed by the line-of-sight direction with respect to the vertex P on the subject 32 of each of the pixel Pd and the pixels P0 to P2 and the normal direction at the vertex P, and the pixel value VPd of the pixel Pd is set by the sum of products of the pixel values VP0 to VP2 and the color synthesis weights W0, W1, and W2.

That is, here, the pixel value VPd of the pixel Pd corresponding to the vertex P on the virtual viewpoint image VP is expressed by the following Formula (1).

VPd=VP0×W0+VP1×W1+VP2×W2 (1)

By the above calculation, the pixel value VPd of the pixel Pd of the virtual viewpoint image VP is determined.

Note that, in general, the color synthesis weights W0, W1, and W2 are set to larger values as the angle between the normal direction at the vertex P and the line-of-sight direction is smaller, that is, closer to the confronting state.

However, as described above, in the synthesis of the pixel values based on the angle formed by the line-of-sight direction in the multi-viewpoint image and the normal direction to the vertex P on the subject 32, an appropriate pixel value is not synthesized, and in the generated virtual viewpoint image, it may seem that a failure has occurred.

### <Classification of Failures Occurring on Virtual Viewpoint Image>

The failures occurring on the virtual viewpoint image are roughly classified into three types.

(First Failure: Case where Multi-Viewpoint Images Having Large Color Synthesis Weights have Low Quality)

The first failure is a failure in a case where blurring, blurring, or the like occurs in a multi-viewpoint image having a large color synthesis weight and image quality is deteriorated.

That is, as illustrated in FIG. 5, a case where a color synthesis weight larger than the pixel value of the image of the viewpoint position Cam1 is set to the pixel value of the image of the viewpoint position Cam1 when the virtual viewpoint image of the virtual viewpoint position VC is generated on the vertex P(t) on the subject X(t) at the time t on the basis of the images of the viewpoint positions Cam0 and Cam1 will be considered.

In this case, as expressed by the cross mark in FIG. 5, regardless of the quality of the image of the vertex P(t) at the viewpoint position Cam0 being lower than the quality of the image of the vertex P(t) at the viewpoint position Cam1, the color synthesis weight is set to be large, so that the image of the vertex P(t) at the virtual viewpoint position VC to be synthesized is dominated by the image of the viewpoint position Cam0 of low quality, and as a result, a failure occurs.

For such a first failure, for example, the failure may be resolved by setting the color synthesis weight of the image of the low-quality viewpoint position Cam0 to zero or an extremely small value and setting the color synthesis weight of the image of the high-quality viewpoint position Cam1 to be large.

Note that, in a case where the vertex P is a metal piece or the like and the angle formed by the normal direction and the viewpoint direction is a specific angle, reflected light stronger than reflected light from another virtual viewpoint may be expressed. In such a case, even if the angle formed by a normal direction and a line-of-sight direction is smaller than that of an image from another line-of-sight direction, a large value may be set as the color synthesis weight.

Therefore, in such a case, there is a possibility that the pixel value of the pixel corresponding to the vertex P in the virtual viewpoint image at the virtual viewpoint position VC is not appropriately expressed in color and it may appear that a failure is occurring.

That is, in a case where the color synthesis weight is set only by the angle formed by the normal direction of each point on the subject 32 and the line-of-sight direction to generate the pixel value of the virtual viewpoint image, a failure may occur on the image.

Therefore, in such a case, for example, similarly to the correspondence in the first failure described above, the color synthesis weight may be set to zero or an extremely small value by regarding the image of the viewpoint position where the reflection at the vertex P that is the metal surface is small as the image of low quality, and the color synthesis weight may be set to be large by regarding the image of the viewpoint position where the reflection at the vertex P that is the metal surface is large as the image of high quality.

### (Second Failure: Reflection of Background in Foreground Portion)

The second failure is a failure that occurs when the color of the background is synthesized with the portion of the foreground at the boundary between the foreground and the background.

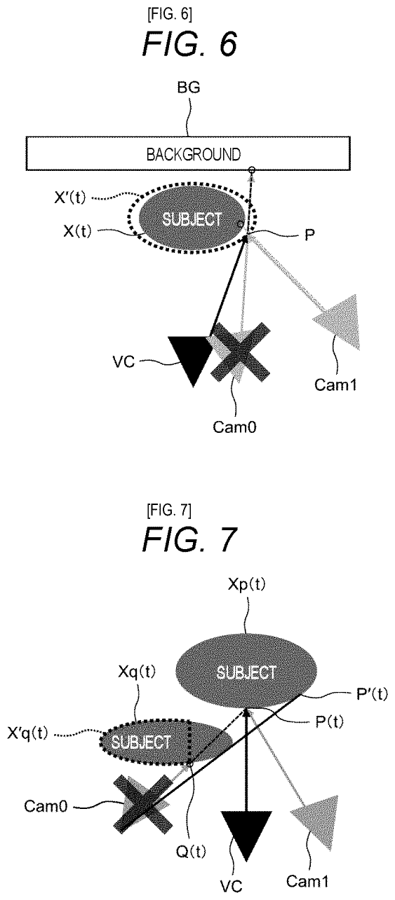

That is, as illustrated in FIG. 6, in a case where the subject X′(t) estimated from the multi-viewpoint image indicated by the dotted line in the drawing is larger than the actual subject X(t) at the time t, the pixel value of the pixel corresponding to the vertex P(t) on the virtual viewpoint image of the virtual viewpoint position VC regarded as the vertex P(t) on the subject X′(t) is synthesized on the basis of the pixel value corresponding to the vertex P on the multi-viewpoint image of the viewpoint positions Cam1 and Cam2.

However, as illustrated in FIG. 6, the image of the vertex P(t) in the image at the viewpoint position Cam2 near the boundary with the background BG in the subject X(t) is the image in which the background BG of the subject X(t) is captured. Therefore, when the image of the vertex P(t) of the subject X(t) captured at the viewpoint position Cam1 and the background BG captured at the viewpoint position Cam0 are synthesized. As a result, the image of the vertex P(t) serving as the foreground and the image of the background BG are synthesized, and as a result, a failure occurs.

For such a second failure, for example, the failure may be solved by setting the color synthesis weight of the image of the viewpoint position Cam0 where the background BG is imaged to zero or an extremely small value and setting the color synthesis weight of the image of the viewpoint position Cam1 where the vertex P(t) is imaged to be large.

### (Third Failure: Reflection of Foreground at Background Portion)

The third failure is a failure that occurs when the color of the object to be the foreground is synthesized with the color of the object on the background side at the boundary between the foreground and the background.

That is, as illustrated in FIG. 7, a case where the actual subjects Xp(t) and Xq(t) at the time t exist, and the subject Xp(t) exists on the background side of the subject Xq(t) with respect to the viewpoint position Cam1 will be considered.

Here, as illustrated in FIG. 7, in a case where the subject X′q(t) estimated from the multi-viewpoint image and indicated by the dotted line has a missing in a part on the right side in the drawing with respect to the actual subject Xq(t) indicated in gray, the pixel value of the vertex P(t) is regarded as not being hidden because the subject Xp(t) in the image from the viewpoint position Cam0 is in a state of being hidden by the boundary of the actual subject Xq(t), but the subject X′q(t) estimated from the multi-viewpoint image is treated in a state where the missing has occurred in a part on the right side as indicated by the dotted line.

As a result, the pixel value of the vertex P(t) of the subject Xq(t) on the virtual viewpoint image at the virtual viewpoint position VC is generated by synthesizing the pixel values on the images of the viewpoint positions Cam1 and Cam2, so that the color of the vertex Q(t) on the subject Xq(t), which is not originally synthesized, is mixed with the color of the vertex P(t) of the subject Xp(t), and a failure occurs.

For such a third failure, for example, the failure may be resolved by setting the color synthesis weight of the image of the viewpoint position Cam0 at which the subject Xq(t) is imaged to zero or an extremely small value and setting the color synthesis weight of the image of the viewpoint position Cam1 at which the subject Xp(t) is imaged to be large.

### <Manual Retouch>

Therefore, as described above, in a case where a failure occurs on the virtual viewpoint image, the failure is corrected by manual retouch.

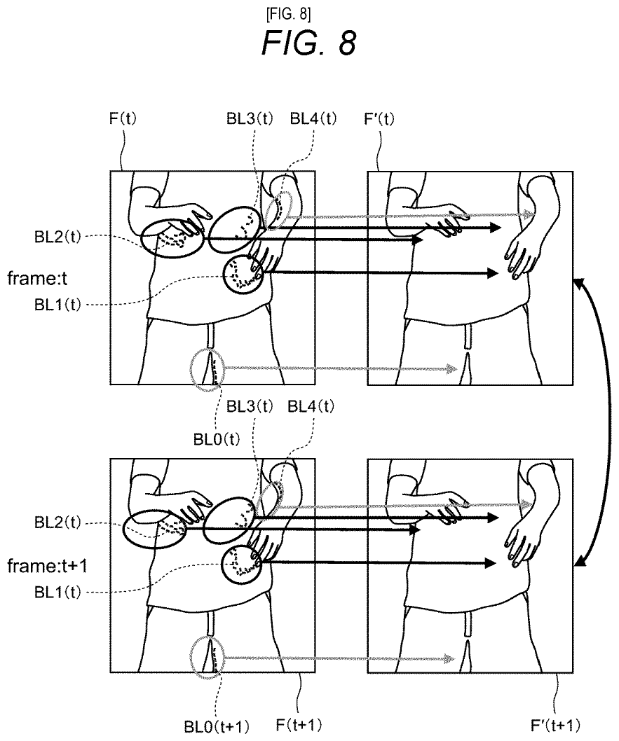

For example, as illustrated in the upper left part of FIG. 8, a case where failures BL0(t) to BL4(t) occur on an image F(t) of a frame t (frame t) which is a frame at time t will be considered.

Here, it is assumed that the failures BL0(t) and BL4(t) on the image F(t) indicate failures in which colors are not appropriately reproduced, and the failures BL1(t) to BL3(t) indicate failures in which patterns are not appropriately reproduced.

Note that the pattern failure is also substantially a failure caused by inappropriate color reproduction, and thus the two failures are substantially the same failure but different in correction method, and thus are distinguished and described here.

In this case, retouch is performed on the failures BL0(t) and BL4(t) by copying and pasting other regions where colors are appropriately reproduced.

Furthermore, for the failures BL1(t) to BL3(t), retouch is performed in which another region where a pattern is appropriately reproduced is copied and pasted.

Through such processing, the image F′(t) is corrected as illustrated in the upper right part of FIG. 8.

However, the work of manually searching for a region in which colors and patterns corresponding to the failure BL0 (t) to BL4 (t) on the image F(t) are appropriately represented, copying the region, and further pasting the region is a very troublesome work.

Furthermore, as illustrated in the lower left part of FIG. 8, even in a case where the failures BL0(t+1) to BL4(t+1) occur on the image F(t+1) of the frame t+1 (frame t+1) which is a frame at the time t+1, the image F′(t+1) as illustrated in the lower right part of FIG. 8 is corrected by similar processing.

However, here, since the images F(t) and F(t+1) change in time series, the images F(t) and F(t+1) are not the same image, and thus the regions in which the colors and patterns are appropriately represented may not be the same in both the images F(t) and F(t+1).

Therefore, the failures BL0(t) to BL4(t) of the original image F(t) and the failures BL0(t+1) to BL4(t+1) in the image F(t+1) are not necessarily the same, and there is a possibility that the pasted regions are not the same in the corrected images F′(t) and F′(t+1).

As described above, in the time-series images F(t) and F(t+1), in a case where images of different regions are pasted and corrected with respect to the failures BL0(t) to BL4(t) and the failures BL0(t+1) to BL4(t+1) occurring at similar positions, the color changes between frames, and thus, there is a possibility that flicker appears to occur.

Therefore, in the present disclosure, when a position where a failure has occurred in a virtual viewpoint image is designated as a failure region by a user, information of a color synthesis weight of a position corresponding to the failure region on the multi-viewpoint image used to generate the virtual viewpoint image is expressed by a color or a pattern and presented to the user, and a user interface (UI) image prompting correction of the color synthesis weight is presented by adjusting the color or the pattern corresponding to the color synthesis weight.

In response to this, when the color synthesis weight in the failure region on the multi-viewpoint image used for generating the virtual viewpoint image is corrected, the virtual viewpoint image is generated with the corrected color synthesis weight as a reference in a state where the color synthesis weight is changed by a value different in several stages from the reference, and is presented as a candidate image of the virtual viewpoint image, and a UI image prompting selection of a candidate image that can be determined to be appropriately corrected to a desired state is presented.

As a result, by generating the virtual viewpoint image by the color synthesis weight applied to the selected candidate image, it is possible to correct the failure in the virtual viewpoint image by adjusting the color synthesis weight that is the intermediate information of the generated virtual viewpoint image.

Moreover, the color synthesis weight applied to the selected candidate image is applied also in generation of virtual viewpoint images that are consecutive in time series before and after the virtual viewpoint image whose failure has been corrected.

With such a configuration, the user can present the candidate images of the plurality of virtual viewpoint images according to the correction content only by roughly designating the region in which the failure occurs and roughly correcting the color synthesis weight of the corresponding region, and further, can correct the failure only by selecting the optimum candidate image in which the desired failure is visually considered to be eliminated from the candidate images.

As a result, it is possible to appropriately correct the failure of the virtual viewpoint image by an easy operation.

Furthermore, since the correction result can be used for other virtual viewpoint images continuous in time series, an inefficient correction operation such as repeating similar correction for a plurality of virtual viewpoint images is not required, and thus it is possible to more easily and appropriately correct the failure of the virtual viewpoint image.

### 2. Preferred Embodiment

### <Outline of Present Disclosure>

An outline of processing for correcting a failure occurring in a virtual viewpoint image according to the present disclosure will be described with reference to a UI image or the like used in the process of the processing.

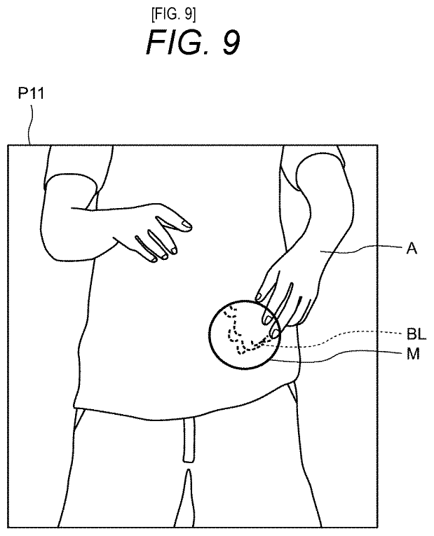

For example, a case where the virtual viewpoint image P11 as illustrated in FIG. 9 is generated will be considered.

Note that the virtual viewpoint image P11 in FIG. 9 is an image in which a body portion of a person is present at the center and the left and right arms are captured. Here, in the virtual viewpoint image P11, it is assumed that a failure portion BL in which a part of the fingertip, which is the tip portion of the arm A, is reflected on the lower left side in the drawing than the position where the fingertip should originally exist is generated.

In such a case, when the user recognizes that the failure portion BL is generated by viewing the virtual viewpoint image P11, the user inputs a mark M including a circle or the like in the drawing so as to surround the failure portion BL in order to designate the position of the recognized failure portion BL, thereby roughly designating the region where the failure portion BL is generated as the failure region. Note that, since the region of the mark M is a failure region designated by the user, the mark M is hereinafter also referred to as a failure region M.

The designation of the failure region M may be input by surrounding the image on which the virtual viewpoint image P11 is displayed using a touch pen or the like, or may be input by tracing with a fingertip in the case of using a touch panel or the like.

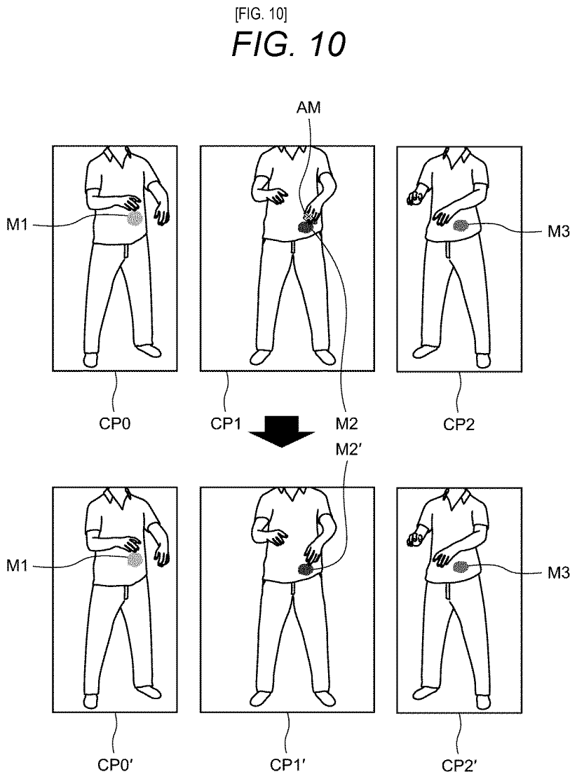

When the failure region M is designated in this manner, for example, as illustrated in the upper part of FIG. 10, the multi-viewpoint image used to generate the virtual viewpoint image P11 is read, and the weight maps CP0 to CP2 in which the information of the color synthesis weight set at the time of generating the virtual viewpoint image P11 on the region corresponding to the failure region M is attached as, for example, the weight information M1 to M3 including colors and patterns according to the magnitude of the color synthesis weight are generated on the read multi-viewpoint image and presented to the user.

Note that FIG. 10 illustrates an example of the weight maps CP0 to CP2 generated on the basis of the multi-viewpoint images used to generate the virtual viewpoint image P11, and weight information M1 to M3 to which colors corresponding to the color synthesis weights set at the positions corresponding to the failure region M are added are displayed in each of the weight maps CP0 to CP2.

In the weight information M1 to M3, the magnitude of the color synthesis weight is expressed by colors and patterns, and the color synthesis weight can be changed by changing the color and pattern with an electronic eraser, brush, brush, or the like.

In this case, as illustrated in FIG. 9, since the failure portion BL is the reflection of the fingertip at the tip of the arm A of the person who is the subject, for example, in order to set the color synthesis weight of the fingertip on the weight map CP1 to 0, it is assumed that the user inputs a mark AM indicated by a cross to the portion of the fingertip. Note that the input for setting the color synthesis weight to 0 may be an input in which the color and pattern gradually disappear using an electronic eraser, brush, brush, or the like.

As a result, since the weight information M2 is edited on the basis of the mark AM, it is corrected to the weight information M2′ as illustrated in the lower part of FIG. 10. This correction can be added to each of the weight maps CP0 to CP2.

Thereafter, when the correction of the weight information M1 to M3 is completed, the color synthesis weight setting is edited on the basis of the corrected weight information, and the weight maps CP0 to CP2 are presented as weight maps CP0′ to CP2′ as illustrated in the lower part of FIG. 10.

Note that, in FIG. 10, since the weight information M2 of the weight map CP1 is only edited as the weight information M2′, only the weight map CP1′ of the weight maps CP0′ to CP2′ is different from the weight map CP1, but the weight maps CP0 and CP2 are set with the same color synthesis weight as the weight maps CP1 and CP2.

Next, the virtual viewpoint image is recreated using the weight maps CP0 to CP2 in which the weight information has been edited.

At this time, for example, the weight setting M2′ is edited such that the color synthesis weight of the fingertip portion is changed to 0 with respect to the weight setting M2, but setting the color synthesis weight to 0 may not necessarily lead to generation of an optimal virtual viewpoint image in which the failure is resolved.

Therefore, in a case where the weight setting M2′ corrects the weight setting M2 to 0, for example, the weight setting M2′ is changed to a plurality of values before and after 0 as a reference, and the virtual viewpoint image is recreated, so that a plurality of candidate images of the virtual viewpoint image in which the desired failure is finally resolved is recreated.

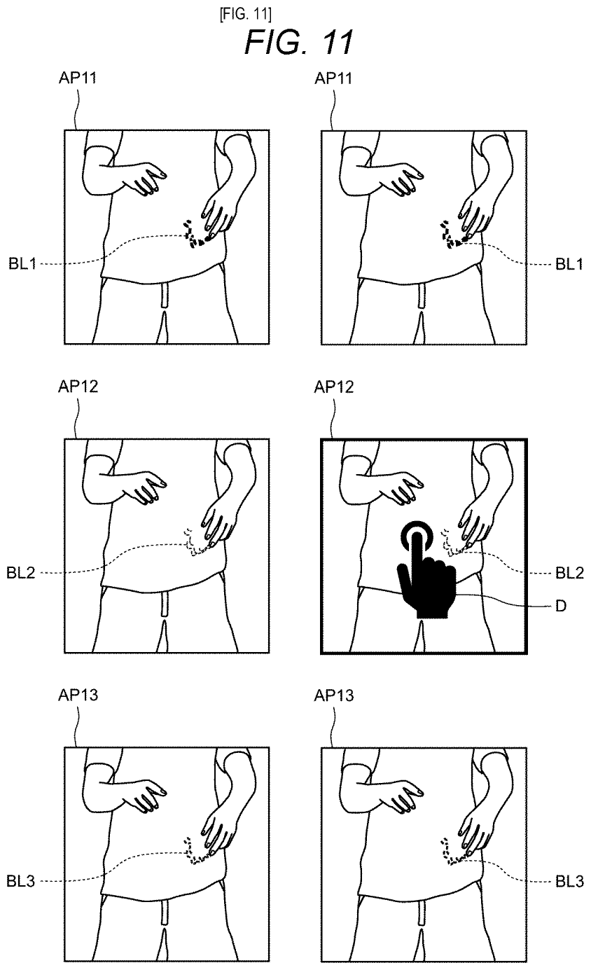

For example, it is assumed that the weight information M2′ is set to three types of predetermined values before and after 0 as a reference, and the candidate images AP11 to AP13 of the virtual viewpoint image including three types of different weight information M2 from the top are generated as illustrated in the left part of FIG. 11.

As the candidate images AP11 to AP13 of the plurality of virtual viewpoint images are generated on the basis of the different weight information M2 in this manner, the failure portion BL changes variously, for example, as in the failure portions BL1 to BL3.

In the left part of FIG. 11, among the failure portions BL1 to BL3 in the candidate images AP11 to AP13, the failures become smaller in the order of the failure portions BL2, BL3, and BL1.

Therefore, in a case where the failure portion BL2 can be regarded as a sufficiently small failure desired by the user, when the candidate image AP12 is selected by the user as indicated by the pointer D on the right side of FIG. 11, correction to the weight setting used when the candidate image AP12 is generated is performed, whereby correction of the failure ends.

Note that, in a case where none of the candidate images AP11 to AP13 is recognized as a sufficiently small failure portion, processing such as changing the designated region of the failure region or changing the method of correcting the color synthesis weight by similar processing may be repeated until it is recognized as a sufficiently small failure portion.

As described above, the failure region can be corrected by only three tasks of designating the failure region, correcting the color synthesis weight, and selecting the candidate image.

As a result, it is possible to easily correct a failure in the virtual viewpoint image.

Furthermore, the color synthesis weight setting corresponding to the correction result made for one virtual viewpoint image is propagated to the virtual viewpoint images within a predetermined range continuous in time series and used.

As a result, regarding the failure occurring in the time-series consecutive virtual viewpoint images, the failure can be corrected by one correction operation by using the corrected color synthesis weight setting of the image so as to propagate.

As a result, it is possible to suppress repetition of inefficient correction work, and it is possible to easily correct a failure in a plurality of consecutive virtual viewpoint images in time series.

Furthermore, since it is possible to uniformly correct the failures of the continuous virtual viewpoint images, it is possible to suppress the occurrence of flicker caused by different corrections made to the failures of the continuous virtual viewpoint images.

However, for correction of a failure in consecutive virtual viewpoint images, it is necessary to take a measure according to the type of the failure.

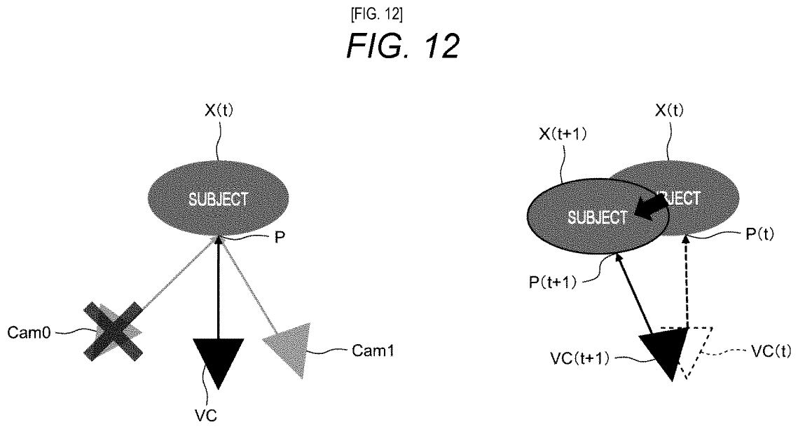

That is, in the case of the first failure described with reference to FIG. 5 (corresponding to the left part of FIG. 12), the failure is corrected by setting the color synthesis weight of the image of the viewpoint position Cam0 to 0 or an extremely small value and setting the color synthesis weight of the image of the high-quality viewpoint position Cam1 to be large at the vertex P(t) of the subject X(t).

Therefore, as illustrated in the right part of FIG. 12, when the subject X(t) at the time t moves like the subject X(t+1) at the time t+1, the vertex P(t+1) of the subject X(t+1) is tracked from the vertex P(t) on the subject X(t) at the time t, and similarly to the case of the vertex P(t), the color synthesis weight of the image of the viewpoint position Cam0 is set to 0 or an extremely small value, and the color synthesis weight of the image of the high-quality viewpoint position Cam1 is set to be large, whereby the failure is corrected.

Thereafter, it is possible to correct the failure by tracking the vertex P(t) in time series and applying the similar color synthesis weight setting. That is, in the right part of FIG. 12, the color synthesis weight setting made at the vertex P(t) of the virtual viewpoint position VC(t) at the time t is also applied to the vertex P(t+1) of the virtual viewpoint position VC(t+1) at the time t+1.

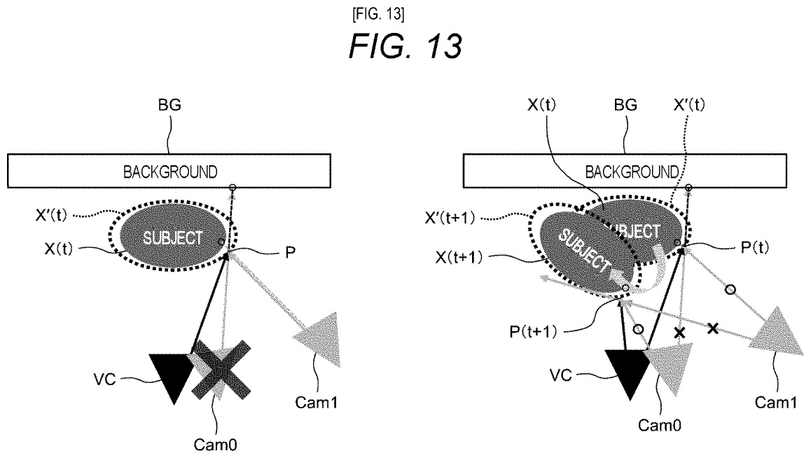

Furthermore, in the case of the second failure described with reference to FIG. 6 (corresponding to the left part of FIG. 13), the failure is corrected by setting the color synthesis weight of the image of the viewpoint position Cam0 where the background BG is imaged to 0 or an extremely small value and setting the color synthesis weight of the image of the viewpoint position Cam1 where the vertex P(t) is imaged to be large in the vicinity of the boundary of the subject X(t).

Therefore, as illustrated in the right part of FIG. 13, when the subject X(t) at the time t moves like the subject X(t+1) at the time t+1, the vertex P(t+1) of the subject X(t+1) is tracked from the vertex P(t) on the subject X(t) at the time t.

In the right part of FIG. 13, since the subject X′(t+1) estimated from the multi-viewpoint image is estimated to be larger than the real subject X(t+1), the image of the viewpoint position Cam1 includes only the image on the background side in the vicinity of the boundary of the subject X(t+1). In other words, in the image of the viewpoint position Cam1, when the vertex P(t+1) of the subject X′(t+1) comes near the boundary of the subject X′(t+1), the image of the subject X′(t+1) is not included.

Therefore, in this case, since the position of the vertex P(t+1) of the subject X′(t+1) in the image of the tracked viewpoint position Cam0 does not become the vicinity of the boundary of the subject X′(t+1) in the image of the viewpoint position Cam0, the color synthesis weight is set to be large. On the other hand, since the vertex P(t+1) of the subject X′(t+1) in the image of the viewpoint position Cam1 is a boundary with the subject X′(t+1), the failure is corrected by setting the color synthesis weight to zero or an extremely small value.

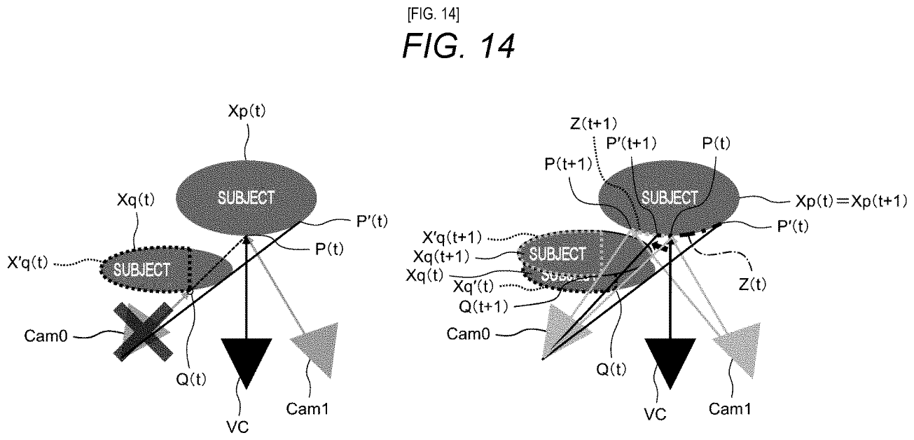

Moreover, in the case of the third failure described with reference to FIG. 7 (corresponding to the left part of FIG. 14), the failure is corrected by setting the color synthesis weight of the image of the viewpoint position Cam0 at which the subject Xq(t) is imaged to 0 or an extremely small value and setting the color synthesis weight of the image of the viewpoint position Cam1 at which the subject Xp(t) is imaged to be large.

Therefore, as illustrated in the right part of FIG. 14, when the subject Xq(t) at the time t moves like the subject Xq(t+1) at the time t+1, the failure is corrected by tracking the failure region Z(t) at the time t indicated by a thick one-dot chain line on the subject X(t) (=Xp(t+1)) at the time t and the failure region Z(t+1) indicated by a thick dotted line on the subject X(t) (=Xp(t+1)) at the time t+1 from the image (two-dimensional image) of the viewpoint position Cam0, for example, and setting the similar color synthesis weight as long as the failure region exists.

That is, in the case of FIG. 14, since the failure region is the occlusion region, the positional relationship cannot be grasped by tracking the subjects Xq(t) and Xq(t+1), and thus the failure region to be the occlusion region is tracked from the image of the viewpoint position Cam0.

Since the position of the subject in the virtual viewpoint image can be identified on the basis of the three-dimensional data of the subject obtained on the basis of the multi-viewpoint image used to generate the corrected virtual viewpoint image, the type of the failure described above can be determined. That is, the three-dimensional model of the subject in the failure region in the virtual viewpoint image is specified, and the type of the failure is specified on the basis of the positional relationship with the subject or the background specified as the three-dimensional model.

Then, the method of tracking the subject is switched according to the specified failure type, and the color synthesis weight set when the failure is corrected is propagated to other virtual viewpoint images continuous in time series.

### <Modification of UI Image>

The display example of the UI image for correcting the failure by designating the failure region, adjusting the color synthesis weight corresponding to the failure region, and selecting the optimum image from the candidate images of the virtual viewpoint image recreated by adjusting the plurality of parameters on the basis of the adjustment result has been described above.

However, in the above example, it is possible to correct an intuitive failure, but it is not possible to perform correction to finely adjust individual color synthesis weights.

Therefore, the individual color synthesis weights in the designated failure region may be directly operated, a UI image capable of correcting the failure may be displayed, and the individual color synthesis weights may be directly adjusted.

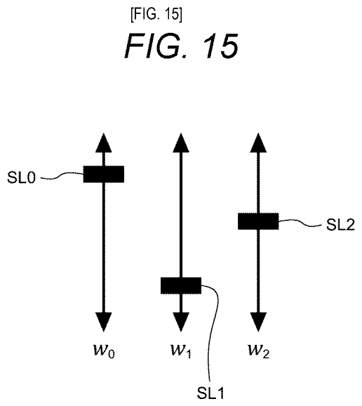

In the display example of the UI image of FIG. 15, the slidacks SL0 to SL2 for adjusting the magnitude of the color synthesis weight of each of the color synthesis weights W0, W1, and W2 are provided, and the magnitude of the color synthesis weight is adjusted by moving up and down within the range of the arrow in the drawing.

That is, for example, in the display example of the UI image of FIG. 15, the color synthesis weight is set to be larger as the positions of the slidacks SL0 to SL2 are in the upper part of the range of the arrow in the drawing, and conversely, the color synthesis weight is set to be smaller as the positions are in the lower part of the drawing.

The magnitude of the color synthesis weight may be directly set in the UI image as illustrated in FIG. 15.

Note that, in the UI image of FIG. 15, the color synthesis weights W0 to W2 can be directly set in detail, but an intuitive operation cannot be performed.

Therefore, the color synthesis weight may be set using both the UI images by switching between the UI image described with reference to FIGS. 9 to 14 and the UI image of FIG. 15.

Furthermore, also in a case where the UI image in FIG. 15 is used, a plurality of color synthesis weights based on the set color synthesis weights W0 to W2 may be set, and a plurality of corresponding virtual viewpoint images may be generated as candidate images.

### <Outline of Information Processing System of Present Disclosure>

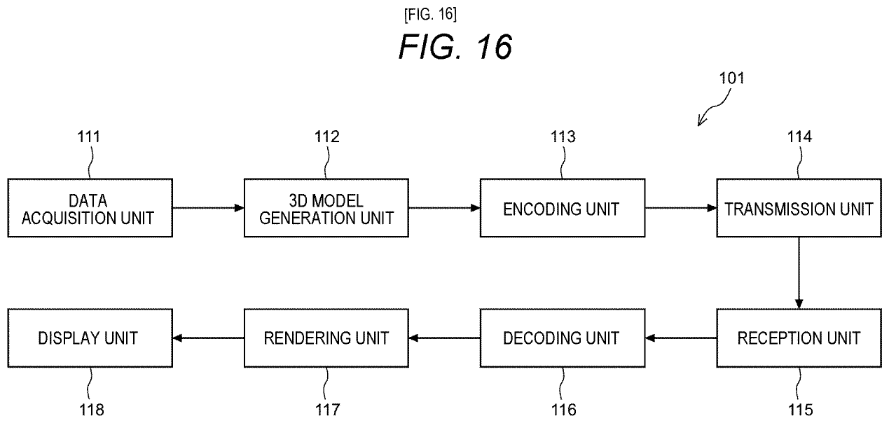

FIG. 16 illustrates an outline of an information processing system to which the technology of the present disclosure is applied.

An information processing system 101 in FIG. 16 includes a data acquisition unit 111, a 3D model generation unit 112, an encoding unit 113, a transmission unit 114, a reception unit 115, a decoding unit 116, a rendering unit 117, and a display unit 118.

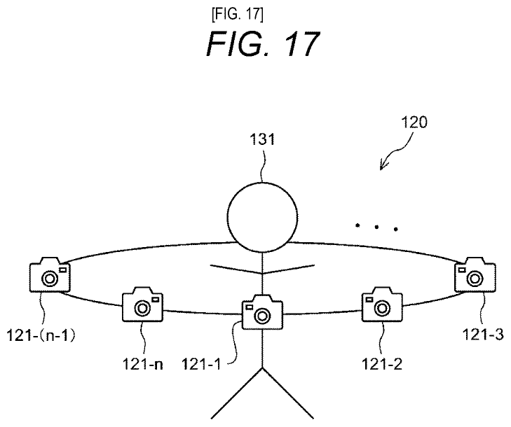

The data acquisition unit 111 acquires image data for generating a 3D model of the subject. For example, as illustrated in FIG. 17, a plurality of viewpoint images captured by a multi-viewpoint imaging system 120 including a plurality of imaging devices 121-1 to 121-n disposed so as to surround a subject 131 is acquired as image data.

Note that, hereinafter, in a case where it is not necessary to particularly distinguish the imaging devices 121-1 to 121-n, the imaging devices are simply referred to as an imaging device 121, and other configurations are similarly referred to. Furthermore, the plurality of viewpoint images is also referred to as multi-viewpoint images.

In this case, the plurality of viewpoint images is preferably images captured by the plurality of imaging devices 121 in synchronization.

Furthermore, the data acquisition unit 111 may acquire, for example, image data obtained by imaging the subject from a plurality of viewpoints by moving one imaging device 121.

Moreover, the data acquisition unit 111 may perform calibration on the basis of the image data and acquire internal parameters and external parameters of each imaging device 121.

Furthermore, the data acquisition unit 111 may acquire, for example, a plurality of pieces of depth information indicating distances from a plurality of viewpoints to the subject.

The 3D model generation unit 112 generates a model having three-dimensional information of the subject 131 on the basis of image data for generating a 3D model of the subject 131.

The 3D model generation unit 112 generates a 3D model of the subject by, for example, scraping the three-dimensional shape of the subject using images (for example, silhouette images from a plurality of viewpoints) from a plurality of viewpoints using a so-called Visual Hull.

In this case, the 3D model generation unit 112 can further deform the 3D model generated using the Visual Hull with high accuracy using a plurality of pieces of depth information indicating distances from viewpoints at a plurality of locations to the subject.

Furthermore, for example, the 3D model generation unit 112 may generate the 3D model of the subject 131 from one captured image of the subject 131.

The 3D model generated by the 3D model generation unit 112 can also be referred to as a moving image of the 3D model by generating the 3D model in units of time-series frames.

Furthermore, since the 3D model is generated using an image captured by the imaging device 121, it can also be referred to as a live-action 3D model.

The 3D model can express shape information representing the surface shape of the subject 131 in the form of mesh data expressed by a connection between vertices called polygon mesh, for example.

The method of representing the 3D model is not limited thereto, and the 3D model may be described by what is referred to as a point cloud representation method that represents the 3D model by position information about points.

Data of color information is also generated as a texture in association with the 3D shape data. For example, there are a case of a View Independent texture in which a color is constant when viewed from any direction and a case of a View Dependent texture in which a color changes depending on a viewing direction.

The encoding unit 113 converts the data of the 3D model generated by the 3D model generation unit 112 into a format suitable for transmission and accumulation.

In the present disclosure, three-dimensional shape data input in a format such as mesh data is converted into a depth information image projected from one or a plurality of viewpoints, that is, a so-called depth map.

The depth information and the color information of the state of the two-dimensional image are compressed and output to the transmission unit.

The depth information and the color information may be transmitted side by side as one image or may be transmitted as two separate images.

Since both are in the form of two-dimensional image data, compression can be performed using a two-dimensional compression technique such as advanced video coding (AVC).

The transmission unit 114 transmits the transmission data formed by the encoding unit 113 to the reception unit 115. The transmission unit 114 performs a series of processing of the data acquisition unit 111, the 3D model generation unit 112, and the encoding unit 113 offline, and then transmits the transmission data to the reception unit 115.

Furthermore, the transmission unit 114 may transmit the transmission data generated from the series of processing described above to the reception unit 115 in real time.

The reception unit 115 receives the transmission data transmitted from the transmission unit 114 and outputs the transmission data to the decoding unit 116.

The decoding unit 116 restores the bit stream received by the reception unit to a two-dimensional image, restores the image data to a mesh and texture information that can be drawn by the rendering unit 117, and outputs the mesh and texture information to the rendering unit 117.

The rendering unit 117 projects the mesh of the 3D model as an image of a viewpoint position to be drawn, performs texture mapping of pasting a texture representing a color or a pattern, and outputs the mesh to the display unit 118 for display. The feature of this system is that the drawing at this time can be arbitrarily set and viewed from a free viewpoint regardless of the viewpoint position of the imaging device 121 at the time of imaging. Hereinafter, an image of a freely settable viewpoint is also referred to as a virtual viewpoint image or a free viewpoint image.

The texture mapping includes what is referred to as a View Dependent method in which the viewing viewpoint of a user is considered and a View Independent method in which the viewing viewpoint of a user is not considered.

Since the View Dependent method changes the texture to be pasted on the 3D model according to the position of the viewing viewpoint, there is an advantage that rendering of higher quality can be achieved than by the View Independent method.

On the other hand, the View Independent method does not consider the position of the viewing viewpoint, and thus there is an advantage that the processing amount is reduced as compared with the View Dependent method.

Note that the display device detects a viewing point (region of interest) of the user, and the viewing viewpoint data is input from a display device to the rendering unit 117.

The display unit 118 displays a result rendered by the rendering unit 117 on a display surface of the display device. The display device may be, for example, a 2D monitor or a 3D monitor, such as a head mounted display, a spatial display, a mobile phone, a television, or a personal computer (PC).

The information processing system 101 in FIG. 16 illustrates a series of flow from the data acquisition unit 111 that acquires the captured image, which is a material for generating the content, to the display unit 118 that controls the display device viewed by the user.

However, not meaning that all functional blocks are necessary for implementation of the present disclosure, the present disclosure can be implemented for each functional block or a combination of a plurality of functional blocks.

For example, the information processing system 101 in FIG. 16 is provided with the transmission unit 114 and the reception unit 115 in order to illustrate a series of flow from a side of creating the content to a side of viewing the content through the distribution of the content data, but in a case where the process from the creation to the viewing of the content is performed by the same information processing apparatus (for example, a personal computer), it is not necessary to include the encoding unit 113, the transmission unit 114, the decoding unit 116, or the reception unit 115.

When the information processing system 101 in FIG. 16 is implemented, the same implementer may implement all the functions, or different implementers may implement each functional block.

As an example, a business operator A generates 3D content through the data acquisition unit 111, the 3D model generation unit 112, and the encoding unit 113. Then, it is conceivable that the 3D content is distributed through the transmission unit (platform) 114 of a business operator B, and the display device of a business operator C performs reception, rendering, and display control of the 3D content.

Furthermore, each functional block can be implemented on a cloud. For example, the rendering unit 117 may be implemented in the display device or may be implemented in a server. In this case, information is exchanged between the display device and the server.

In FIG. 16, the data acquisition unit 111, the 3D model generation unit 112, the encoding unit 113, the transmission unit 114, the reception unit 115, the decoding unit 116, the rendering unit 117, and the display unit 118 are collectively described as the information processing system 101.

However, the information processing system 101 of the present specification is referred to as information processing system 101 when two or more functional blocks are related, and for example, the data acquisition unit 111, the 3D model generation unit 112, the encoding unit 113, the transmission unit 114, the reception unit 115, the decoding unit 116, and the rendering unit 117 can be collectively referred to as information processing system 101 without including the display unit 118.

### <Virtual Viewpoint Image Display Process>

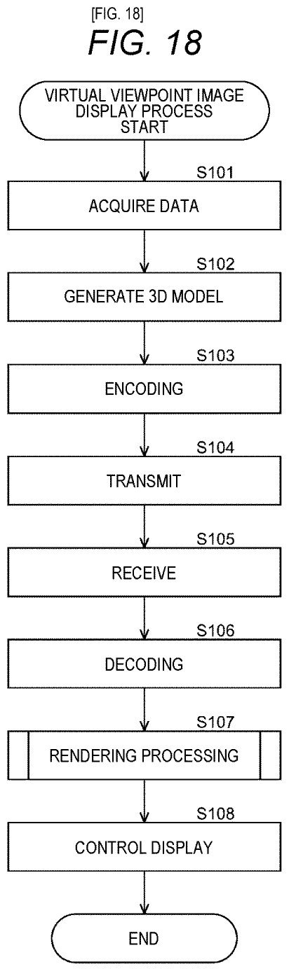

Next, an example of a flow of a virtual viewpoint image display process by the information processing system 101 in FIG. 16 will be described with reference to the flowchart in FIG. 18.

In step S101, the data acquisition unit 111 acquires image data for generating the 3D model of the subject 131, and outputs the image data to the 3D model generation unit 112.

In step S102, the 3D model generation unit 112 generates a model having three-dimensional information of the subject 131 on the basis of image data for generating a 3D model of the subject 131, and outputs the model to the encoding unit 113.

In step S103, the encoding unit 113 encodes the shape and texture data of the 3D model generated by the 3D model generation unit 112 into a format suitable for transmission and accumulation, and outputs the encoded data to the transmission unit 114.

In step 104, the transmission unit 114 transmits the encoded data.

In step 105, the reception unit 115 receives the transmitted data and outputs the data to the decoding unit 116.

In step 106, the decoding unit 116 performs decoding processing, converts the data into shape and texture data necessary for display, and outputs the data to the rendering unit 117.

In step 107, the rendering unit 117 executes rendering processing to be described later, renders the virtual viewpoint image using the shape and texture data of the 3D model, and outputs the virtual viewpoint image as a rendering result to the display unit 118.

In step 108, the display unit 118 displays the virtual viewpoint image that is a rendering result.

When the processing in step S108 ends, the virtual viewpoint image display process by the information processing system 101 ends.

### <Configuration Example of Rendering Unit>

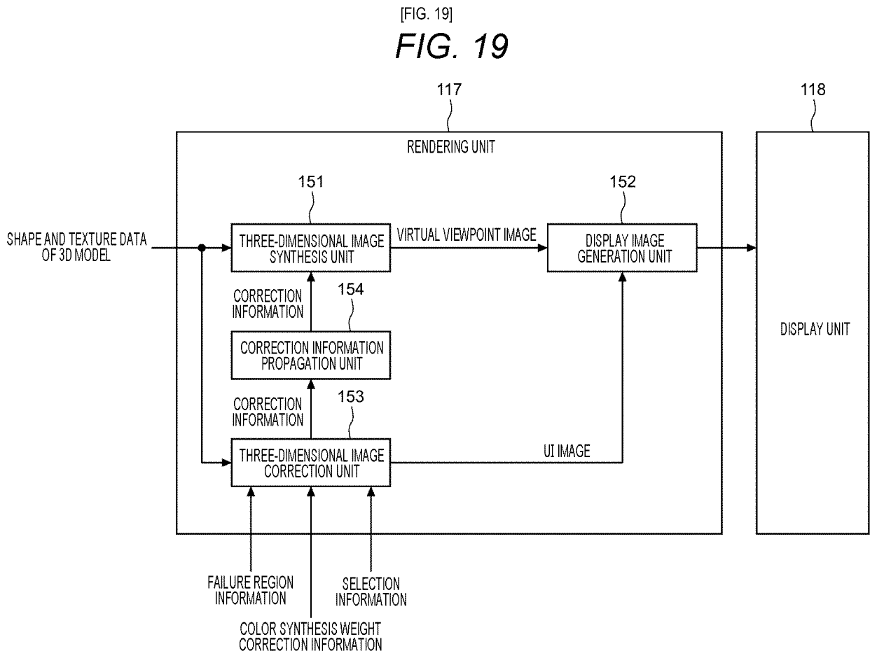

Next, a detailed configuration of the rendering unit 117 will be described with reference to FIG. 19.

As described above, the rendering unit 117 generates a virtual viewpoint image by the rendering processing on the basis of the 3D model generated from the multi-viewpoint image captured by the multi-viewpoint imaging system 120 as illustrated in FIG. 17, for example, and displays the virtual viewpoint image on the display unit 118.

Furthermore, in a case where a failure occurs in the virtual viewpoint image generated by the rendering processing, the rendering unit 117 of the present disclosure corrects the failure in accordance with an operation input from the user.

Note that, in this example, while the rendering unit 117 generates the virtual viewpoint image by the rendering processing and sequentially displays the virtual viewpoint image on the display unit 118, the description will proceed on the assumption that the failure correction is performed by receiving the operation input from the user, but only the failure correction may be executed offline after the rendering processing is completed.

The rendering unit 117 includes a three-dimensional image synthesis unit 151, a display image generation unit 152, a three-dimensional image correction unit 153, and a correction information propagation unit 154.

The three-dimensional image synthesis unit 151 acquires information of the shape and texture of the 3D model generated on the basis of the multi-viewpoint image supplied from the decoding unit 116, and synthesizes virtual viewpoint images including the three-dimensional image. Note that it is assumed that information of the virtual viewpoint position is input in advance by the user in synthesizing the virtual viewpoint images, and the virtual viewpoint image is a virtual viewpoint image corresponding to the virtual viewpoint position input by the user.

The synthesis of the virtual viewpoint image including the three-dimensional image by the three-dimensional image synthesis unit 151 is substantially image synthesis by the product-sum obtained by adding the color synthesis weight according to the virtual viewpoint position described with reference to FIG. 4 to (the image corresponding to) the multi-viewpoint image restored by the information of the shape and texture of the 3D model.

Therefore, the three-dimensional image synthesis unit 151 sets the color synthesis weight according to an angle between the normal direction of the subject and the line-of-sight direction from the viewpoint position for each pixel of the multi-viewpoint image restored by the information of the shape and texture of the 3D model according to the virtual viewpoint position by the rendering processing, generates the three-dimensional image as the virtual viewpoint image at the virtual viewpoint position by the rendering processing using the product-sum operation to which the set color synthesis weight is added, and outputs the virtual viewpoint image to the display image generation unit 152.

At this time, in a case where the correction information including the color synthesis weight corrected by the three-dimensional image correction unit 153 according to the operation input of the user is stored in advance in the correction information propagation unit 154, the three-dimensional image synthesis unit 151 executes the rendering processing using the corrected color synthesis weight stored as the correction information in the correction information propagation unit 154 to synthesize the three-dimensional image of the virtual viewpoint position, and outputs the synthesized result to the display image generation unit 152 as the virtual viewpoint image.

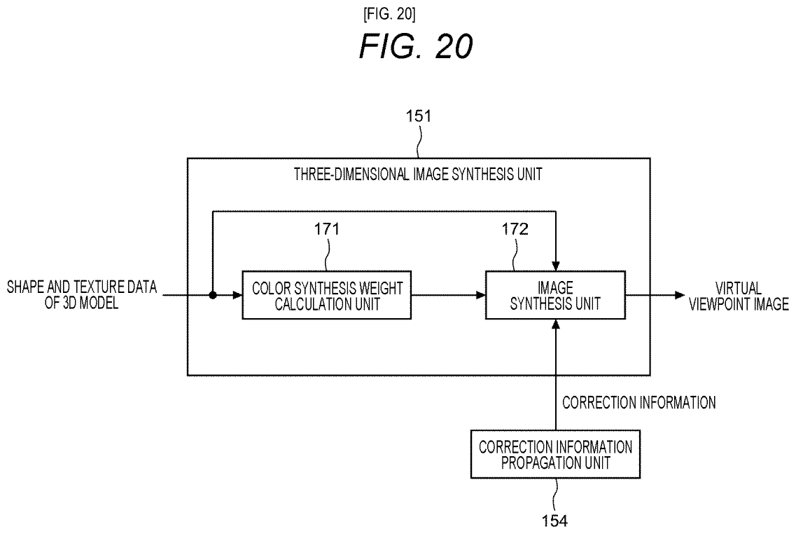

Note that a detailed configuration of the three-dimensional image synthesis unit 151 will be described later with reference to FIG. 20.

The display image generation unit 152 receives the virtual viewpoint image including the three-dimensional image supplied from the three-dimensional image synthesis unit 151 and a user interface (UI) image required for correction of the virtual viewpoint image supplied from the three-dimensional image correction unit 153, and generates and displays a display image that can be displayed on the display unit 118.

The three-dimensional image correction unit 153 receives an operation input from the user, executes processing of correcting a failure occurring in a virtual viewpoint image including a three-dimensional image as a rendering result displayed on the display unit 118, and stores a correction result in the correction information propagation unit 154 as correction information.

More specifically, the three-dimensional image correction unit 153 corrects the failure by adjusting the color synthesis weight as the intermediate data, that is, by adjusting the inappropriate color synthesis weight.

At this time, the three-dimensional image correction unit 153 realizes desired correction in a small number of steps while suppressing an extreme decrease in the degree of freedom on the basis of three operation inputs from the user, that is, designation of a failure region, correction information of a color synthesis weight, and selection of a candidate image to be a correction result.

For example, the three-dimensional image correction unit 153 presents the UI image described with reference to FIGS. 9 to 11 described above on the display unit 118, adjusts the color synthesis weight by attaching three operation inputs from the user of designation of the failure region, correction information of the color synthesis weight, and selection of the candidate image to be the correction result, corrects the failure, and stores the correction result in the correction information propagation unit 154 as the correction information.

Furthermore, the three-dimensional image correction unit 153 may present the UI image described with reference to FIG. 15 on the display unit 118 so that the color synthesis weight can be individually adjusted, correct the failure, and store the correction result as correction information in the correction information propagation unit 154.

Note that, as described above, since the correction of the color synthesis weight using the UI image described with reference to FIGS. 9 to 11 is intuitive and correction by a simple operation, it is possible to realize easy correction of the failure for the user.

However, in the correction of the color synthesis weight using the UI image described with reference to FIGS. 9 to 11, the correction content may be slightly rough.

On the other hand, in the correction of the color synthesis weight using the UI image described with reference to FIG. 15, fine adjustment of individual color synthesis weights is possible, but there are many combinations and intuitive correction is not possible.

Therefore, the correction of the color synthesis weight using the UI image described with reference to FIGS. 9 to 11 and the correction of the color synthesis weight using the UI image described with reference to FIG. 15 may be switched and used.

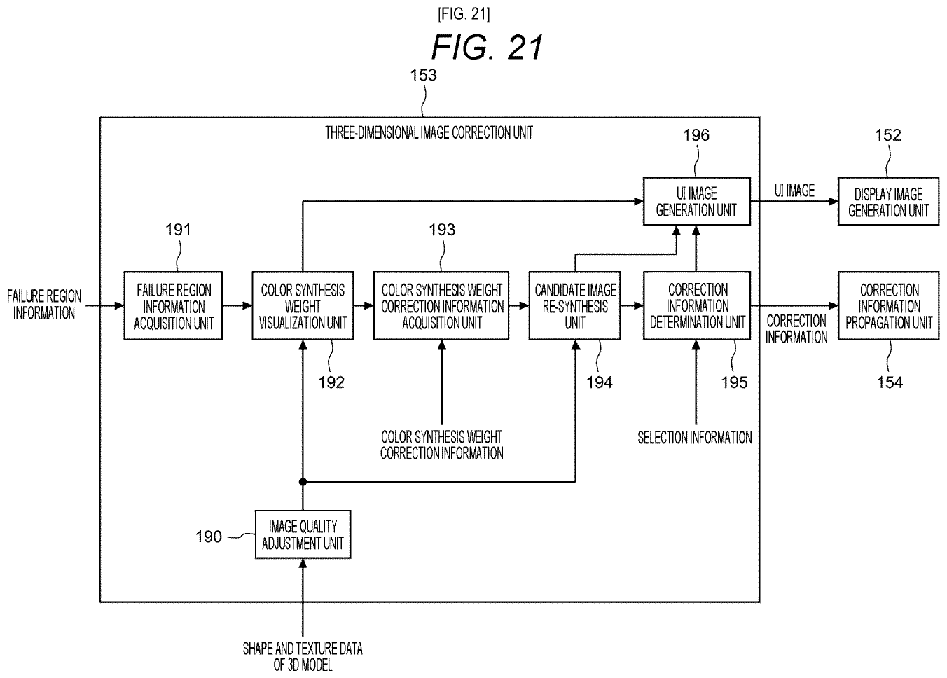

Note that a detailed configuration of the three-dimensional image correction unit 153 will be described later with reference to FIG. 21.

The correction information propagation unit 154 includes, for example, a memory and the like, stores the correction information generated by adjusting the color synthesis weight as the intermediate data supplied from the three-dimensional image correction unit 153, and supplies the correction information to the three-dimensional image synthesis unit 151.

### <Configuration Example of Three-Dimensional Image Synthesis Unit>

Next, a configuration example of the three-dimensional image synthesis unit 151 will be described with reference to FIG. 20.

The three-dimensional image synthesis unit 151 includes a color synthesis weight calculation unit 171 and an image synthesis unit 172.

The color synthesis weight calculation unit 171 calculates a color synthesis weight according to an angle formed by the line-of-sight direction from each pixel of the multi-viewpoint image to be substantially restored and the normal direction of the subject and an angle formed by the line-of-sight direction from the virtual viewpoint position and the normal direction of the subject on the basis of the information of the shape and the texture of the 3D model supplied from the decoding unit 116, and supplies the calculated color synthesis weight to the image synthesis unit 172.

The image synthesis unit 172 performs rendering by synthesizing each pixel in the multi-viewpoint image to be substantially restored by product-sum operation using the color synthesis weight supplied from the color synthesis weight calculation unit 171 on the basis of the information of the shape and texture of the 3D model supplied from the decoding unit 116, and outputs a virtual viewpoint image as a rendering result to the display image generation unit 152.

Furthermore, in a case where the correction information generated at the time of correction of the failure made by the three-dimensional image correction unit 153 is stored in the correction information propagation unit 154, the image synthesis unit 172 reads the correction information stored in the correction information propagation unit 154, generates a three-dimensional image of the virtual viewpoint position as a rendering image that is a rendering result by product-sum operation using a color synthesis weight as the correction information for each pixel in the multi-viewpoint image to be substantially restored on the basis of the information of the shape and texture of the 3D model supplied from the decoding unit 116, and outputs the rendering image to the display image generation unit 152.

Note that, when the correction information is used, as described with reference to FIGS. 12 to 14, in order to switch the method of using the correction information according to the type of the failure, the image synthesis unit 172 may buffer the shape and texture data of the 3D model for generating virtual viewpoint images for several frames, track the subject in consecutive frames, and switch the method of using the correction information on the basis of a tracking result.

Furthermore, as a tracking method, for example, Mesh-tracking can be cited as one of calculation methods of corresponding point information between frames of a 3D model. The Mesh-tracking is a method of searching for a corresponding point by fitting a shape of a predetermined frame to another frame as a template in a case where a geometry is a mesh.

### <Configuration Example of Three-Dimensional Image Synthesis Unit>

Next, a configuration example of the three-dimensional image correction unit 153 will be described with reference to FIG. 21.

The three-dimensional image correction unit 153 includes an image quality adjustment unit 190, a failure region information acquisition unit 191, a color synthesis weight visualization unit 192, a color synthesis weight correction information acquisition unit 193, a candidate image re-synthesis unit 194, a correction information determination unit 195, and a UI image generation unit 196.

The image quality adjustment unit 190 generates the multi-viewpoint images used to generate the virtual viewpoint image on the basis of the information of the shape and texture of the 3D model supplied from the decoding unit 116, and determines whether or not the image quality of at least one of the generated multi-viewpoint images is higher than a predetermined level.

In a case where at least one of the multi-viewpoint images used for generating the virtual viewpoint image has a quality higher than a predetermined level, the image quality adjustment unit 190 directly outputs the multi-viewpoint image to the color synthesis weight visualization unit 192 and the candidate image re-synthesis unit 194.

On the other hand, in a case where none of the multi-viewpoint images used for generating the virtual viewpoint image is higher in quality than the predetermined level, there is a possibility that a failure has occurred because the multi-viewpoint image is lower in quality than the predetermined level. Therefore, there is a possibility that the failure cannot be corrected even if correction is directly made.

Therefore, the image quality adjustment unit 190 improves the quality by, for example, inpainting processing or the like, and outputs the improved quality to the color synthesis weight visualization unit 192 and the candidate image re-synthesis unit 194.

Note that, as long as the multi-viewpoint images used for generating the virtual viewpoint image can be improved in quality, processing other than the inpainting processing may be used.

As described with reference to FIG. 9, the failure region information acquisition unit 191 acquires, as the failure region information, a region in the virtual viewpoint image designated on the basis of the operation input of the user in which a failure is considered to occur, and outputs the failure region information to the color synthesis weight visualization unit 192.

The color synthesis weight visualization unit 192 substantially generates the multi-viewpoint images used to generate the virtual viewpoint image on the basis of the information of the shape and texture of the 3D model.

Moreover, on the basis of the failure region information supplied from the failure region information acquisition unit 191, the color synthesis weight visualization unit 192 generates an image that visualizes the color synthesis weight set for the failure region corresponding to the images CP0 to CP2 described with reference to FIG. 10, for example, with a color, a pattern, or the like according to the color synthesis weight. Note that the color synthesis weight can also be obtained by the color synthesis weight visualization unit 192 by a method similar to the method calculated by the color synthesis weight calculation unit 171.

Then, the color synthesis weight visualization unit 192 outputs an image visualizing information of the color synthesis weight set in the generated failure region to the color synthesis weight correction information acquisition unit 193 and the UI image generation unit 196.

The color synthesis weight correction information acquisition unit 193 acquires color synthesis weight correction information added to an image that visualizes information of the color synthesis weight set in the failure region, for example, like the mark AM described with reference to FIG. 9, in response to the user's operation input, and outputs information of the color synthesis weight including the corrected color synthesis weight in the range designated as the failure region to the candidate image re-synthesis unit 194 as the color weight correction information.

The candidate image re-synthesis unit 194 substantially generates the multi-viewpoint images used to generate the virtual viewpoint image on the basis of the information of the shape and texture of the 3D model, and re-synthesizes the candidate images of the virtual viewpoint images as illustrated by the images AP11 to AP13 in FIG. 11, for example, using the color synthesis weight corrected in the region designated as the failure region on the basis of the color synthesis weight correction information, and outputs the candidate images to the UI image generation unit 196 and the correction information determination unit 195.

More specifically, on the basis of the color synthesis weight correction information, the candidate image re-synthesis unit 194 re-synthesizes the candidate images of the plurality of virtual viewpoint images using a plurality of different color synthesis weights in the vicinity thereof with the color synthesis weight corrected in the region designated as the failure region as a reference, outputs the re-synthesized candidate images to the UI image generation unit 196, and outputs the re-synthesized candidate images to the correction information determination unit 195.

At this time, the candidate image re-synthesis unit 194 may further change parameters other than the color synthesis weight to a plurality of different values on the basis of the color synthesis weight correction information, thereby re-synthesizing the candidate images of the plurality of virtual viewpoint images.

Another parameter may be, for example, reflectance or absorptivity of light of the subject, or in a case where a pixel is used as a unit, a pixel value of a pixel in the vicinity thereof, a normal direction of a point on the subject, for example, corresponding to the above-described vertex P, or the like may be changed so as to use the normal direction of a point in the vicinity of the vertex P, or the like.

The correction information determination unit 195 receives an operation input from the user to select one of the candidate images AP11 to AP13, for example, receives an input of selection information such as a pointer D in FIG. 11, and stores correction information including a color synthesis weight and other parameters set to the selected candidate image in the correction information propagation unit 154.

At this time, information corresponding to a valid period of the correction information such as a period during which the correction information stored in the correction information propagation unit 154 is valid and how many frames ahead of the current frame are valid may be set.

Furthermore, the correction information may include, for example, information for identifying the type of failure described above with reference to FIGS. 12 to 14 and the corresponding correction content.

As described above, the information on the type of the failure and the correction content is included in the correction information, so that it is possible to switch the correction content for the tracked subject in the virtual viewpoint image in which the correction information is propagated, which is continuous in time series with respect to the virtual viewpoint image in which the failure is corrected.

### <Rendering Processing by Rendering Unit in FIG. 19>

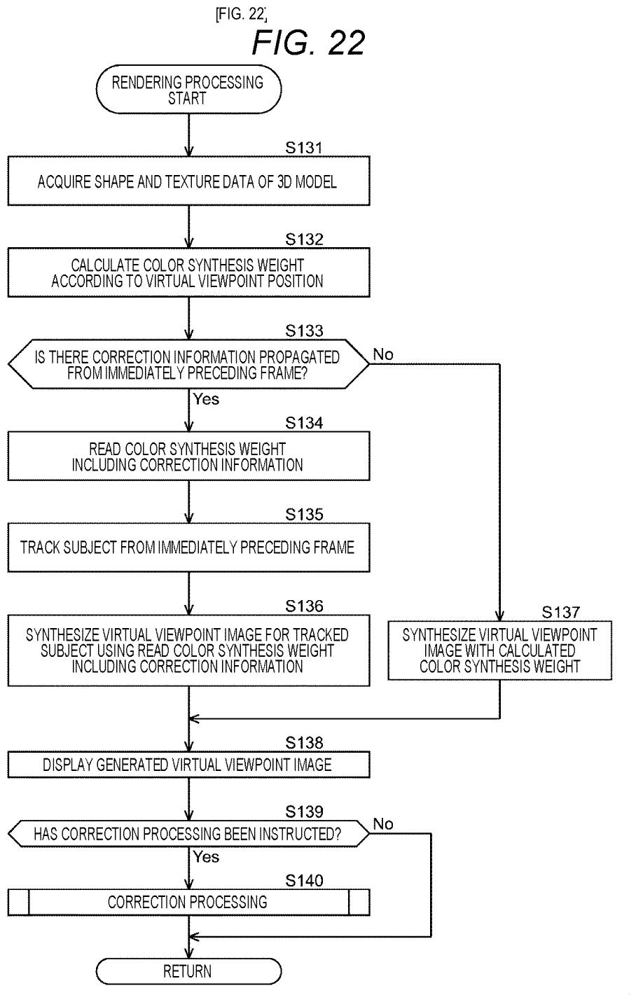

Next, the rendering processing by the rendering unit 117 in FIG. 19 will be described with reference to the flowchart in FIG. 22.

In step S131, the three-dimensional image synthesis unit 151 acquires information of the shape and texture of the 3D model generated on the basis of the multi-viewpoint image supplied from the decoding unit 116.

In step S132, the color synthesis weight calculation unit 171 of the three-dimensional image synthesis unit 151 calculates the color synthesis weight according to the angle between the normal direction of the subject and the line-of-sight direction from the viewpoint position for each pixel of the multi-viewpoint image restored by the information of the shape and texture of the 3D model according to the virtual viewpoint position, and outputs the color synthesis weight to the image synthesis unit 172.

In step S133, the image synthesis unit 172 determines whether or not the correction information propagated from the immediately preceding frame is stored in the correction information propagation unit 154.

In a case where it is determined in step S133 that the correction information propagated from the immediately preceding frame is stored in the correction information propagation unit 154, the processing proceeds to step S134.

In step S134, the image synthesis unit 172 reads the correction information stored in the correction information propagation unit 154.

In step S135, the image synthesis unit 172 specifies the type of the failure on the basis of the correction information, and tracks the subject on the basis of the virtual viewpoint images for the last several frames.

In step S136, the image synthesis unit 172 synthesizes the virtual viewpoint image for the tracked subject by rendering based on the read correction information, and outputs the synthesized virtual viewpoint image to the display image generation unit 152.

On the other hand, in a case where it is determined in step S133 that the correction information propagated from the previous frame is not stored in the correction information propagation unit 154, the processing proceeds to step S137.

In step S137, the image synthesis unit 172 synthesizes the virtual viewpoint image by rendering with the color synthesis weight calculated by the color synthesis weight calculation unit 171, and outputs the synthesized virtual viewpoint image to the display image generation unit 152.

In step S138, the display image generation unit 152 outputs the virtual viewpoint image supplied from the image synthesis unit 172 to the display unit 118 for display.

In step S139, the three-dimensional image correction unit 153 confirms the operation input by the user, and determines whether or not correction has been instructed to the displayed virtual viewpoint image.

In step S139, for example, in a case where the user is instructed to correct a failure by an operation input by confirming that a failure has occurred in the virtual viewpoint image displayed on the display unit 118, the processing proceeds to step S140.

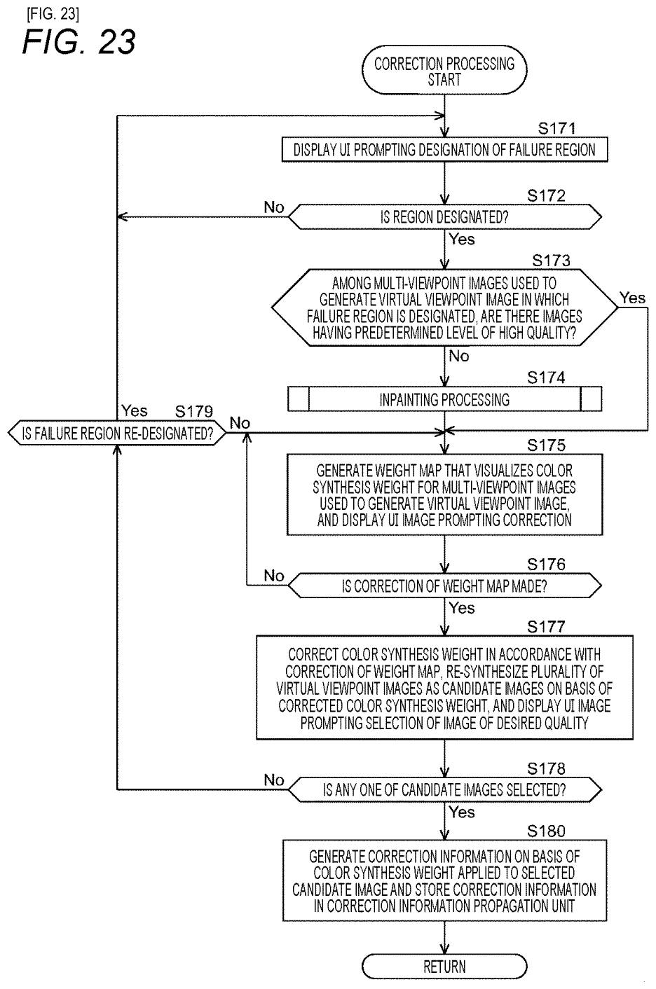

In step S140, the three-dimensional image correction unit 153 executes correction processing to correct a failure occurring in the virtual viewpoint image, and the rendering processing ends. Note that the correction processing will be described later in detail with reference to the flowchart of FIG. 23.

Furthermore, in a case where correction is not instructed in step S139, the processing in step S140 is skipped, and the rendering processing ends.

Note that the correction processing will be described later in detail with reference to the flowchart of FIG. 23.

Through the above processing, on the basis of the shape and texture data of the 3D model, the virtual viewpoint images are synthesized on the basis of the multi-viewpoint image according to the virtual viewpoint and the color synthesis weight calculated from the multi-viewpoint image or the color synthesis weight based on the correction information generated before the previous frame and stored in the correction information propagation unit 154.

### <Correction Processing by Three-Dimensional Image Correction Unit in FIG. 21>

Next, the correction processing by the three-dimensional image correction unit 153 in FIG. 21 will be described with reference to a flowchart in FIG. 23.

In step S171, the UI image generation unit 196 displays, on the display unit 118, a UI image prompting designation of the failure region in the virtual viewpoint image currently displayed on the display unit 118.

In step S172, the failure region information acquisition unit 191 determines whether or not information designating the failure region in the virtual viewpoint image currently displayed on the display unit 118 is input on the basis of the user's operation input, and repeats the similar processing until it is determined that the information is input.

In a case where it is determined in step S172 that the failure region in the virtual viewpoint image currently displayed is designated, the failure region information acquisition unit 191 outputs failure region information, which is information designating the failure region in the virtual viewpoint image currently displayed, to the color synthesis weight visualization unit 192 on the basis of the user's operation input, and the processing proceeds to step S173.

In step S173, the image quality adjustment unit 190 generates the multi-viewpoint images used to generate the virtual viewpoint image on the basis of the information of the shape and texture of the 3D model supplied from the decoding unit 116, and determines whether or not the image quality of at least one of the generated multi-viewpoint images is higher than a predetermined level.

In step S173, in a case where none of the multi-viewpoint images used for generating the virtual viewpoint image is higher in quality than the predetermined level, the processing proceeds to step S174.

In step S174, the image quality adjustment unit 190 improves the quality by the inpainting processing, and outputs the improved quality to the color synthesis weight visualization unit 192 and the candidate image re-synthesis unit 194.

Note that, in step S173, in a case where any of the multi-viewpoint images used to generate the virtual viewpoint image has the quality higher than the predetermined level, the processing of step S174 is skipped.

In step S175, the color synthesis weight visualization unit 192 substantially generates the multi-viewpoint images used to generate the virtual viewpoint image on the basis of the information of the shape and texture of the 3D model.

Moreover, on the basis of the failure region information supplied from the failure region information acquisition unit 191, the color synthesis weight visualization unit 192 generates, for example, the color synthesis weight set in the failure region corresponding to the images CP0 to CP2 described with reference to FIG. 10 as a weight map for visualizing the color synthesis weight by, for example, a color, a pattern, or the like according to the color synthesis weight, and outputs the weight map to the color synthesis weight correction information acquisition unit 193 and the UI image generation unit 196.

In response to this, the UI image generation unit 196 generates a UI image as illustrated in FIG. 10, for example, for displaying information prompting correction of the color synthesis weight in the failure region together with the weight map according to the color synthesis weight, and displays the UI image on the display unit 118.

In step S176, the color synthesis weight correction information acquisition unit 193 determines whether or not the information for correcting the color synthesis weight is input and the correction is made on the basis of the operation input of the user, and in a case where it is not determined that the correction is made, the processing returns to step S175.

That is, the processing of steps S175 and S176 is repeated until the information for correcting the color synthesis weight is input.

Then, in step S176, in a case where it is determined that the information for correcting the color synthesis weight has been input in addition to the image for visualizing the information of the color synthesis weight set in the failure region, for example, as the mark AM described with reference to FIG. 9, the color synthesis weight correction information acquisition unit 193 outputs the information for correcting the input color synthesis weight to the candidate image re-synthesis unit 194 as the color synthesis weight correction information, and the processing proceeds to step S177.

In step S177, the candidate image re-synthesis unit 194 substantially generates the multi-viewpoint images used to generate the virtual viewpoint image on the basis of the information of the shape and texture of the 3D model, and re-synthesizes the candidate images of the virtual viewpoint image as illustrated by the images AP11 to AP13 in FIG. 11 using the color synthesis weight corrected in the region designated as the failure region on the basis of the color synthesis weight correction information, and outputs the candidate images to the UI image generation unit 196 and the correction information determination unit 195.

More specifically, on the basis of the color synthesis weight correction information, the candidate image re-synthesis unit 194 re-synthesizes the candidate images of the plurality of virtual viewpoint images using a plurality of different color synthesis weights in the vicinity thereof based on the color synthesis weight corrected in the region designated as the failure region.

In response to this, the UI image generation unit 196 generates the UI image prompting the selection of the candidate image of the plurality of virtual viewpoint images and any of the candidate images of which the failure can be considered to be sufficiently corrected as described with reference to FIG. 11, and displays the generated UI image on the display unit 118.

In step S178, the correction information determination unit 195 receives an operation input from the user and determines whether or not any one of the candidate images is selected.

In step S178, for example, one of the candidate images AP11 to AP13 in FIG. 11 is selected, for example, in a case where it is determined that one of the candidate images is selected by input of selection information such as the pointer D, the processing proceeds to step S180.

In step S180, the correction information determination unit 195 causes the correction information propagation unit 154 to store the correction information including the color synthesis weight and other parameters applied to the virtual viewpoint image to be the selected candidate image among the plurality of candidate images of the virtual viewpoint images and the information on the type of the failure on the basis of the selection information, and ends the processing.

At this time, information corresponding to a valid period of the correction information such as a period during which the correction information stored in the correction information propagation unit 154 is valid and how many frames ahead of the current frame are valid may be set.

Furthermore, in the correction processing, in a case where the multi-viewpoint images used to generate the virtual viewpoint image in which the failure region is designated do not include the predetermined level of high quality image and the image quality is improved by the inpainting processing, information on what kind of improvement has been made may be included in the correction information.

That is, there may be a case where the multi-viewpoint images used for generating the virtual viewpoint image are low in quality. Therefore, in such a case, not only the corrected color synthesis weight but also information indicating what kind of high quality has been made by the inpainting processing or the like may be included as the correction information, and the failure may be corrected after similar improvement of the image quality is made in the subsequent processing.

On the other hand, in step S178, in a case where the operation input from the user is received, and any of the candidate images is not selected, and for example, the re-correction of the failure is instructed, the processing proceeds to step S179. At this time, the UI image generation unit 196 displays, for example, a UI image inquiring whether or not to newly re-designate a failure region.

In step S179, the failure region information acquisition unit 191 determines whether or not a new failure region is re-designated.

In a case where the failure region is re-designated in step S179, the processing returns to step S171, and the subsequent processing is repeated.

Furthermore, in a case where the failure region is not re-designated in step S179, the processing returns to step S175.

That is, in a case where the failure is corrected again, a new failure region is designated, and the failure is corrected again, or the color synthesis weight in the failure region designated first is corrected again, so that the failure is corrected repeatedly, and the similar processing is repeated until the failure is corrected.

With the above processing, in a state where the virtual viewpoint image is generated by the rendering processing and displayed on the display unit 118, when the user instructs to correct the failure, the correction processing is started.

When the failure region is designated, a weight map image that is a color synthesis weight map of a region corresponding to the failure region in the multi-viewpoint images used to generate the virtual viewpoint image is generated, and correction of the weight map is prompted.

Then, when the weight map is corrected, a plurality of virtual viewpoint images is generated and presented as candidate images on the basis of the corresponding color synthesis weights, and when a candidate image for which the failure is considered to be corrected is selected, information on the color synthesis weight used to generate the virtual viewpoint image to be the selected candidate image, other parameters, and information regarding the type of the failure and the correction content are stored in the correction information propagation unit 154 as correction information.

As a result, the user can correct the failure that occurs in the virtual viewpoint image only by designating the failure region in the virtual viewpoint image, correcting the color synthesis weight in the failure region on the multi-viewpoint images used to generate the virtual viewpoint image, and selecting an image in which the failure is considered to be corrected to a level desired by the user from among the candidate images of the virtual viewpoint image generated by correcting the color synthesis weight.

Furthermore, when the failure in one virtual viewpoint image is corrected in the moving images of the virtual viewpoint images continuous in time series, correction information including information such as the color synthesis weight corrected when the failure is corrected, other parameters, the type of the failure, and the correction method is stored in the correction information propagation unit 154. As a result, similar correction information can be used so as to be propagated to the virtual viewpoint images generated in subsequent time series, and a failure occurring in a plurality of virtual viewpoint images can also be realized by one correction.

### 3. Modifications

In the above, an example has been described in which the user designates a failure region in the generated virtual viewpoint image, corrects the color synthesis weight in the multi-viewpoint images used to generate the virtual viewpoint image, a candidate image of a plurality of virtual viewpoint images is presented according to a correction result, the failure is corrected on the basis of the color synthesis weight applied to the selected candidate image by selecting a candidate image of a desired quality, and correction information including various parameters including the color synthesis weight used for correction is generated.

However, the failure of the virtual viewpoint image may be corrected on the basis of the generated learning information by learning the detection of the failure region and the correction case for the detected failure region by machine learning such as deep learning from the shape and texture of the 3D model used to generate the virtual viewpoint image and the correction information, and generating the learning information.

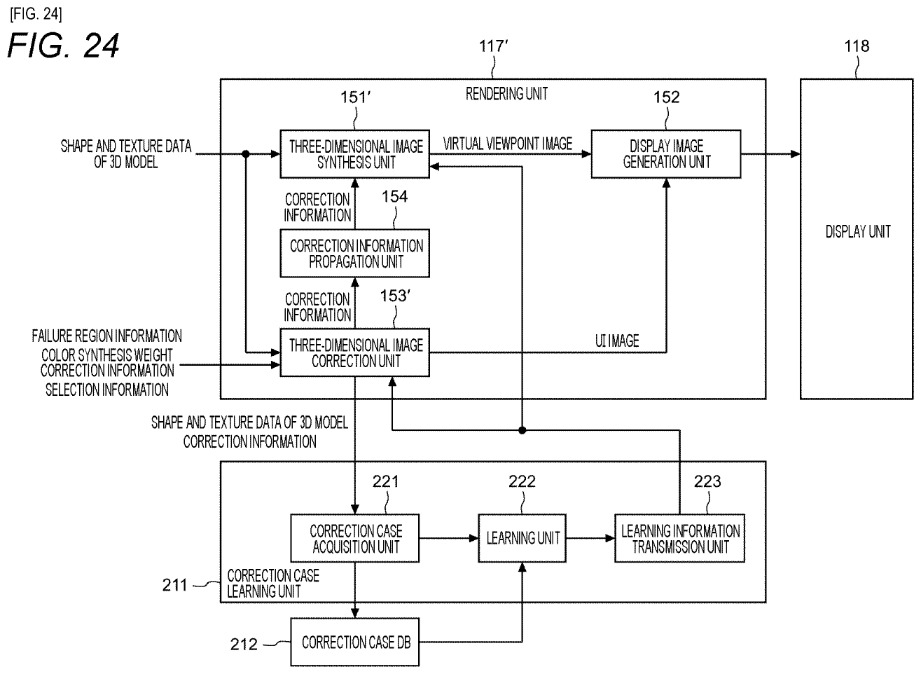

FIG. 24 illustrates a configuration example of a rendering unit 117′ capable of correcting a failure of a virtual viewpoint image by learning, and a correction case learning unit 211 that generates learning information by learning detection of a failure region and a correction case of the detected failure region.

Note that, in the rendering unit 117′ in FIG. 24, configurations having the same functions as those of the rendering unit 117 in FIG. 19 are denoted by the same names and the same reference signs, and the description thereof will be appropriately omitted.

The rendering unit 117′ in FIG. 24 is different from the rendering unit 117 in FIG. 19 in that a three-dimensional image synthesis unit 151′ and a three-dimensional image correction unit 153′ are provided instead of the three-dimensional image synthesis unit 151 and the three-dimensional image correction unit 153.

The three-dimensional image synthesis unit 151′ has the same basic function as the three-dimensional image synthesis unit 151, but further has a function of detecting a failure region and correcting the detected failure region on the basis of the learning information supplied by the correction case learning unit 211.

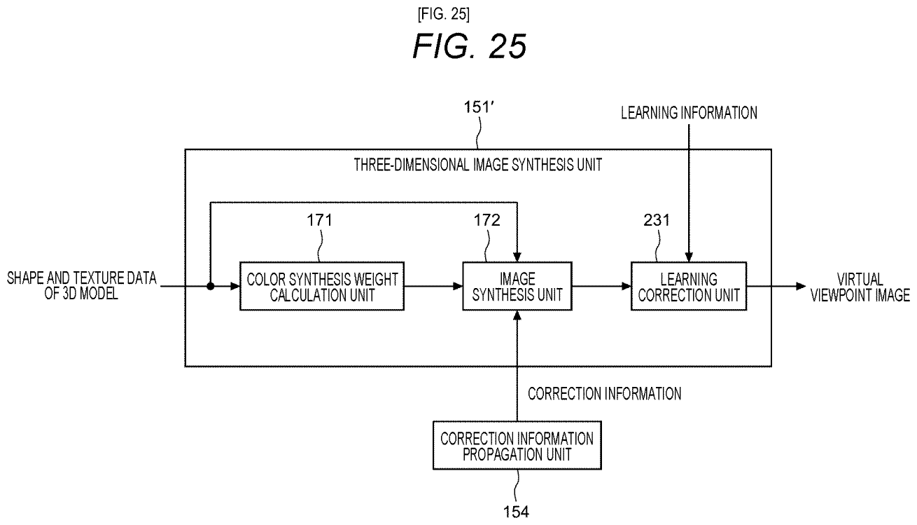

Note that a detailed configuration of the three-dimensional image synthesis unit 151′ will be described later with reference to FIG. 25.

Although the basic function of the three-dimensional image correction unit 153′ is the same as that of the three-dimensional image correction unit 153, when the weight map is generated by visualizing the color synthesis weight, the detection of the failure region and the color synthesis weight when the detected failure region is corrected are considered on the basis of the learning information supplied by the correction case learning unit 211.

Furthermore, the three-dimensional image correction unit 153′ stores the correction information generated by performing the correction processing in the correction information propagation unit 154, and supplies the shape and texture data of the 3D model used when the correction information is generated and the correction information to the correction case learning unit 211 in association with each other.

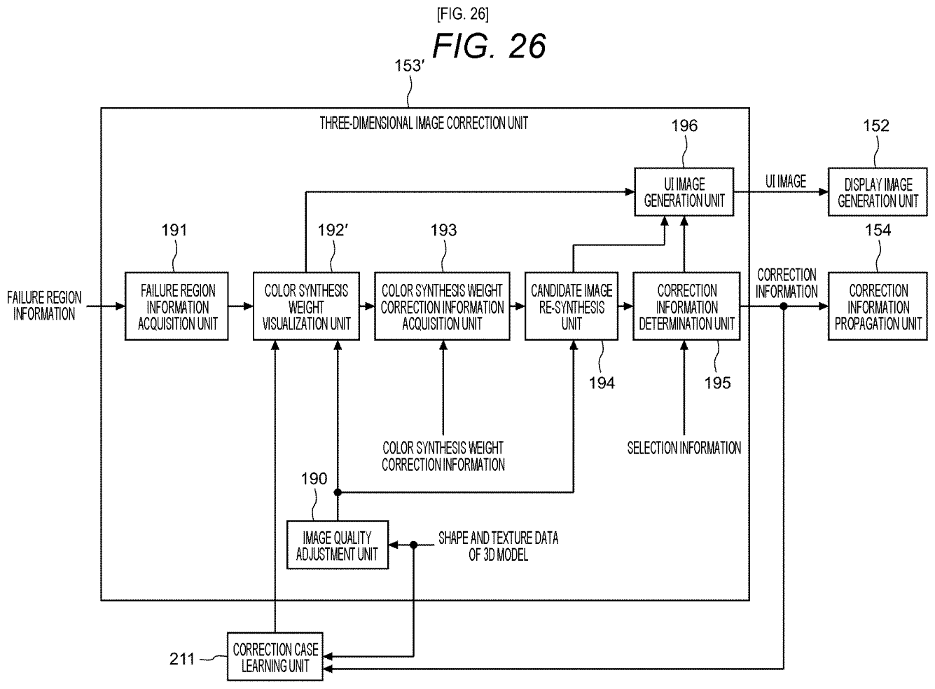

Note that a detailed configuration of the three-dimensional image correction unit 153′ will be described later with reference to FIG. 26.

The correction case learning unit 211 acquires the correction information supplied when the correction processing is performed by the three-dimensional image correction unit 153′ of the rendering unit 117′ in association with the shape and texture data of the corresponding 3D model, and registers the correction information and the corresponding shape and texture data in a correction case database (DB) 212.

On the basis of the correction information registered in the correction case database (DB) 212 and the shape and texture data of the corresponding 3D model, the correction case learning unit 211 learns detection of a failure region in a virtual viewpoint image generated from the shape and texture data of the 3D model and a correction case for the detected failure region, and supplies learning information which is a learning result to the rendering unit 117′.

The correction case learning unit 211 is realized by a server computer or cloud computing capable of communicating with the information processing system 101 via a network.

The correction case learning unit 211 includes a correction case acquisition unit 221, a learning unit 222, and a learning information transmission unit 223.

The correction case acquisition unit 221 acquires the correction information and the shape and texture data of the 3D model supplied from the three-dimensional image correction unit 153′ of the rendering unit 117′ in association with each other, stores the correction information in the correction case DB 212, and supplies the correction information to the learning unit 222.

The learning unit 222 learns the detection of the failure region in the virtual viewpoint image generated from the shape and texture data of the 3D model and the correction case for the detected failure region on the basis of the correction case stored in the correction case DB 212 and the correction case supplied from the correction case acquisition unit 221, generates learning information (for example, artificial intelligence (AI) data) for realizing the detection of the failure region in the virtual viewpoint image generated from the shape and texture data of the 3D model and the correction of the detected failure region, and supplies the learning information to the learning information transmission unit 223.

The learning information transmission unit 223 transmits the learning information (for example, AI data) supplied from the learning unit 222 to the rendering unit 117′.

The correction case DB 212 has a configuration realized by, for example, a storage device such as a hard disc drive (HDD) or a solid state drive (SSD) capable of communicating with the correction case learning unit 211, a server computer configured on a network, or cloud computing, and stores the correction information supplied from the correction case learning unit 211 and the shape and texture data of the 3D model in association with each other and supplies the same as necessary.

### <Configuration Example of Three-Dimensional Image Synthesis Unit in FIG. 24>

Next, a configuration example of the three-dimensional image synthesis unit 151′ in FIG. 24 will be described with reference to FIG. 25.

The three-dimensional image synthesis unit 151′ in FIG. 25 is different from the three-dimensional image synthesis unit 151 in FIG. 20 in that a learning correction unit 231 is newly provided.

On the basis of the learning information supplied from the correction case learning unit 211, the learning correction unit 231 detects a failure region on the virtual viewpoint image generated by the image synthesis unit 172, applies correction corresponding to the detected failure region, and outputs a virtual viewpoint image in which the failure is corrected.

Note that the correction processing by the three-dimensional image correction unit 153′ is also possible for the virtual viewpoint image for which the failure region has been corrected by the learning correction unit 231.

### <Configuration Example of Three-Dimensional Image Correction Unit in FIG. 24>

Next, a configuration example of the three-dimensional image correction unit 153′ in FIG. 24 will be described with reference to FIG. 26.

The three-dimensional image correction unit 153′ of FIG. 26 is different from the three-dimensional image correction unit 153 of FIG. 21 in that a color synthesis weight visualization unit 192′ is provided instead of the color synthesis weight visualization unit 192, and when the correction information is registered in the correction information propagation unit 154, the correction information is output to the correction case learning unit 211 in association with the shape and texture data of the corresponding 3D model.

The basic function of the color synthesis weight visualization unit 192′ is similar to that of the color synthesis weight visualization unit 192, but is different in that when a weight map generated by visualizing color synthesis weights is generated, color synthesis weights in consideration of the correction made by the learning correction unit 231 of the above-described three-dimensional image synthesis unit 151′ are applied.

That is, since the weight map generated by the color synthesis weight visualization unit 192′ is applied with the color synthesis weight in consideration of the correction made by the learning correction unit 231 of the three-dimensional image synthesis unit 151′, it is possible to more easily recognize what kind of correction is intuitively added when correcting the color synthesis weight in the multi-viewpoint image set as the failure region by the user.

As a result, it is possible to easily correct the failure region.

### <Rendering Processing by Rendering Unit in FIG. 24>

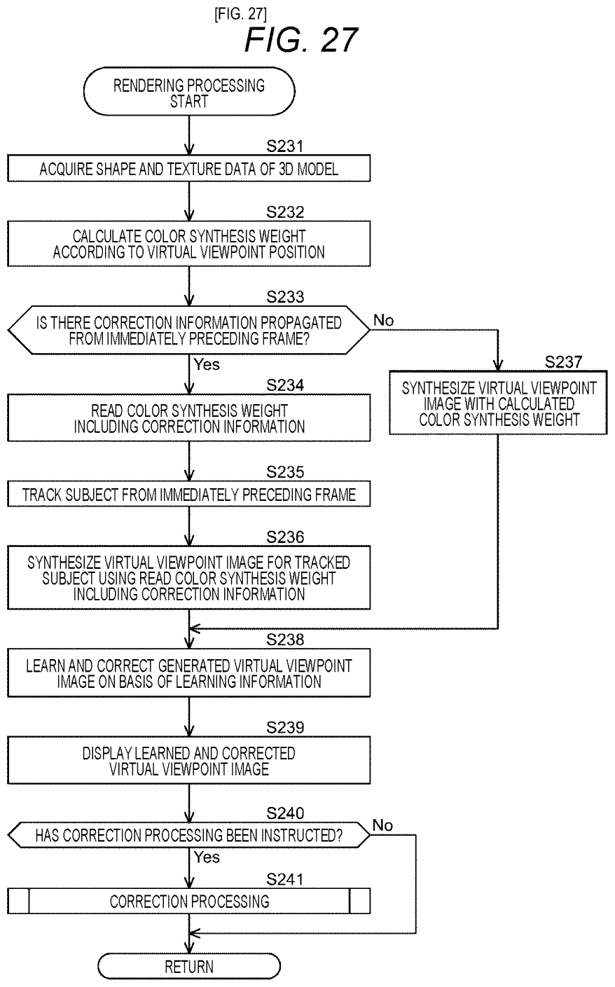

Next, the rendering processing by the rendering unit 117′ in FIG. 24 will be described with reference to the flowchart in FIG. 27.

Note that the processing of steps S231 to S237, S240, and S241 in the flowchart of FIG. 27 is the same as the processing of steps S131 to S137, S139, and S140 described with reference to the flowchart of FIG. 22, and thus the description thereof will be omitted.

That is, when the virtual viewpoint image is generated by the processing of steps S231 to S237, by the processing of step S238, the learning correction unit 231 detects the failure region in the virtual viewpoint image supplied from the image synthesis unit 172 on the basis of the learning information supplied from the correction case learning unit 211, and performs correction processing on the detected failure region to output the virtual viewpoint image in which the failure is corrected.

Then, in step S239, the display image generation unit 152 outputs the virtual viewpoint image of which the failure is corrected by the learning information by the learning correction unit 231 to the display unit 118 for display.

According to the above processing, it is possible to detect the failure region in the virtual viewpoint image on the basis of the learning information obtained from the learning of the correction case, perform correction processing on the detected failure region, and output the virtual viewpoint image in which the failure is corrected.

As a result, it is possible to reduce the burden on the user to correct the failure region.

### <Correction Processing by Three-Dimensional Image Correction Unit in FIG. 26>

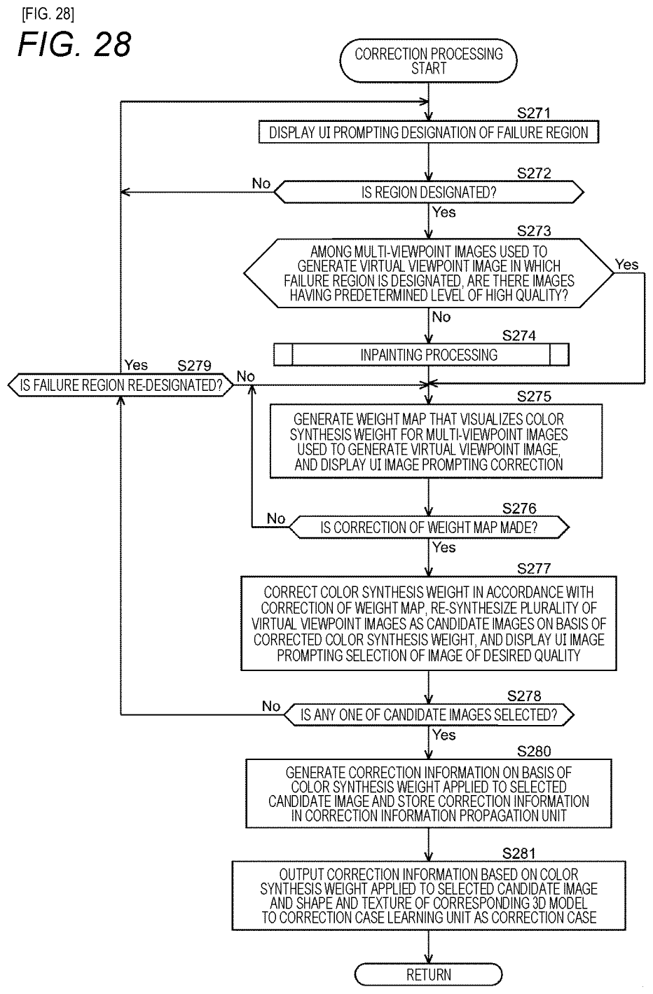

Next, the correction processing by the three-dimensional image correction unit 153′ in FIG. 26 will be described with reference to the flowchart in FIG. 28.

Note that the processing of steps S271 to S274 and S276 to S280 in the flowchart of FIG. 28 is similar to the processing of steps S171 to S174 and S176 to S180 described with reference to the flowchart of FIG. 23, and thus the description thereof will be omitted.

That is, when the failure region of the virtual viewpoint image is designated by the processing of steps S271 to S274, and the multi-viewpoint image generated as the virtual viewpoint image is converted into the high quality image of the predetermined level as necessary, in step S275, the color synthesis weight visualization unit 192′ generates a weight map for visualizing the color synthesis weight set in the failure region in consideration of the learning information by, for example, a color, a pattern, or the like according to the color synthesis weight on the basis of the failure region information supplied from the failure region information acquisition unit 191, and outputs the weight map to the color synthesis weight correction information acquisition unit 193 and the UI image generation unit 196.

In response to this, the UI image generation unit 196 generates a UI image as illustrated in FIG. 10, for example, for displaying information prompting correction of the color synthesis weight in the failure region together with the weight map according to the color synthesis weight, and displays the UI image on the display unit 118.

Moreover, correction of the color synthesis weight based on the weight map is made by the processing of steps S276 to S280, candidate images of a plurality of virtual viewpoint images are generated on the basis of the corrected color synthesis weight, any candidate image is selected, correction information is generated, and the correction information is stored in the correction information propagation unit 154, then the processing proceeds to step S281.

In step S281, the correction information determination unit 195 outputs the correction information together with the shape and texture data of the corresponding 3D model to the correction case learning unit 211 as a correction case.

With the above processing, it is possible to correct the color synthesis weight by the weight map in which the color synthesis weight based on the learning information is considered, it is possible to intuitively correct the color synthesis weight, it is possible to easily correct the failure region desired by the user, and it is possible to improve the correction accuracy.

Furthermore, since the correction case is supplied to the correction case learning unit 211, it is possible to detect a failure occurring in the virtual viewpoint image and learn learning information for realizing correction for the detected failure.

### <Learning Processing by Correction Case Learning Unit>

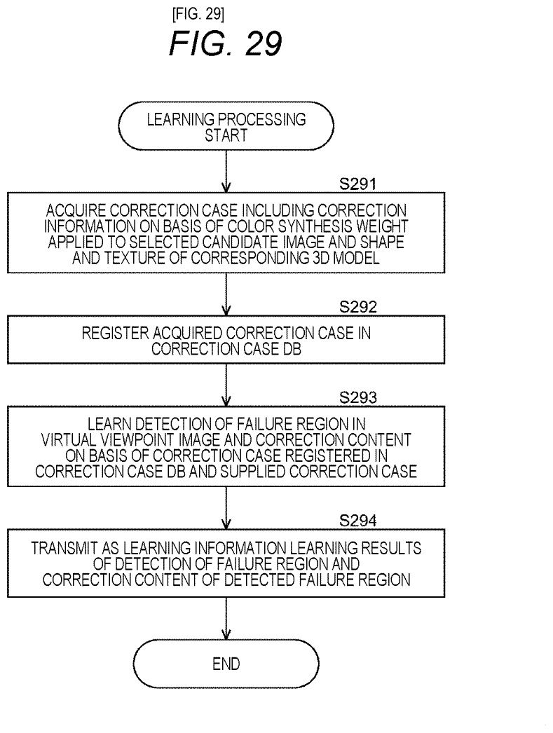

Next, the learning processing by the correction case learning unit 211 will be described with reference to a flowchart of FIG. 29.

In step S291, the correction case acquisition unit 221 acquires the correction case including the correction information and the shape and texture data of the corresponding 3D model supplied from the rendering unit 117′.

In step S292, the correction case acquisition unit 221 stores the acquired correction case in the correction case DB 212 and supplies the correction case to the learning unit 222.

In step S293, the learning unit 222 acquires the correction case supplied from the correction case acquisition unit 221, acquires the correction case stored in the correction case DB 212, learns the detection of the failure region in the virtual viewpoint image generated from the shape and texture data of the 3D model and the correction method of the detected failure region on the basis of the acquired correction case, and outputs the learning result to the learning information transmission unit 223.

In step S294, the learning information transmission unit 223 transmits learning information that is the learning result to the rendering unit 117′.

Through the above processing, the correction cases are accumulated, and further, the detection of the failure region in the virtual viewpoint image generated from the shape and texture data of the 3D model and the correction method of the detected failure region are learned on the basis of the accumulated correction cases, and the learning information as the learning result is supplied to the rendering unit 117′.

As a result, the rendering unit 117′ can detect the failure region in the virtual viewpoint image on the basis of the learning information obtained from the learning of the correction case, perform correction processing on the detected failure region, and output the virtual viewpoint image in which the failure is corrected.

As a result, it is possible to reduce the burden on the user to correct the failure region.

### 4. Example of Execution by Software

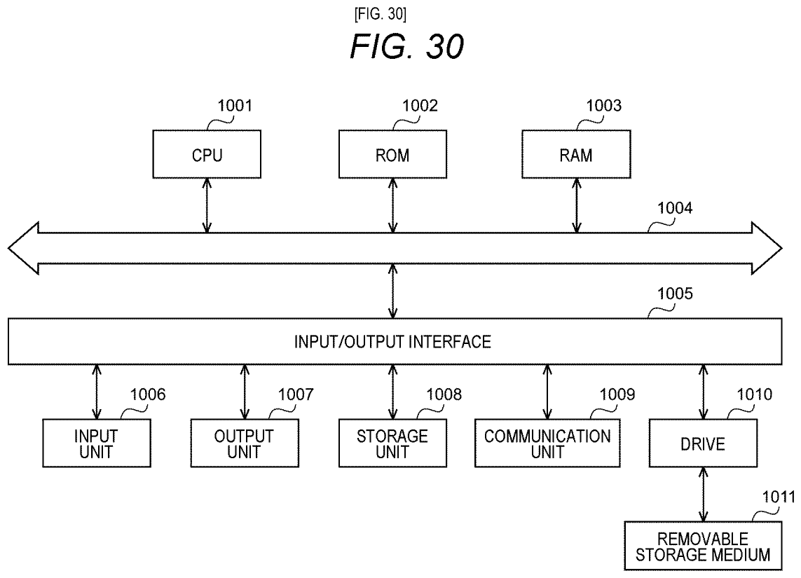

FIG. 30 is a block diagram illustrating a configuration example of hardware of a general-purpose computer that executes the above-described series of processing by a program. In the general-purpose computer illustrated in FIG. 30, a CPU 1001, a ROM 1002, and a RAM 1003 are connected to one another via a bus 1004.

An input/output interface 1005 is also connected to the bus 1004. An input unit 1006, an output unit 1007, a storage unit 1008, a communication unit 1009, and a drive 1010 are connected to the input/output interface 1005.

The input unit 1006 includes, for example, a keyboard, a mouse, a microphone, a touch panel, an input terminal, and the like. The output unit 1007 includes, for example, a display, a speaker, an output terminal, and the like. The storage unit includes, for example, a hard disk, a RAM disk, a nonvolatile memory, and the like. The communication unit 1009 includes, for example, a network interface. The drive 1010 drives a removable storage medium 1011 such as a magnetic disk, an optical disk, a magneto-optical disk, or a semiconductor memory.

In the computer configured as described above, for example, the CPU 1001 loads a program stored in the storage unit 1008 into the RAM 1002 via the input/output interface 1005 and the bus 1004 and executes the program, whereby the above-described series of processing is performed. The RAM 1002 also appropriately stores data and the like necessary for the CPU 1001 to execute various processing.

The program executed by the computer can be applied, for example, by being recorded in the removable storage medium 1011 as a package medium or the like. In that case, the program can be installed in the storage unit 1008 via the input/output interface 1005 by attaching the removable storage medium 1011 to the drive 1010.

Furthermore, the program can also be provided via a wired or wireless transmission medium such as a local area network, the Internet, or digital satellite broadcasting. In this case, the program can be received by the communication unit 1009 and installed in the storage unit 1008.

### 5. Application Example

The technology according to the present disclosure can be applied to various products and services.

### (5-1. Production of Content)

For example, new video content may be produced by synthesizing the 3D model of a subject generated in the present embodiment with 3D data managed by another server. Furthermore, for example, in a case where there is background data acquired by the imaging device 121 such as Lidar, by combining the 3D model of the subject generated in the present embodiment and the background data, it is also possible to create content as if the subject is at a place indicated by the background data.

Note that the video content may be three-dimensional video content or two-dimensional video content converted into two dimensions. Note that examples of the 3D model of the subject generated in the present embodiment include a 3D model generated by the 3D model generation unit and a 3D model reconstructed by the rendering unit 117 (FIG. 16).

### (5-2. Experience in Virtual Space)

For example, the subject (for example, a performer) generated in the present embodiment can be arranged in a virtual space that is a place where the user communicates as an avatar. In this case, the user has an avatar and can view a subject of a live image in the virtual space.

(5-3. Application to Communication with Remote Location)

For example, by transmitting the 3D model of the subject generated by the 3D model generation unit 112 (FIG. 16) from the transmission unit 114 (FIG. 16) to a remote place, a user at the remote place can view the 3D model of the subject through a reproduction device at the remote place. For example, by transmitting the 3D model of the subject in real time, the subject and the user at the remote location can communicate with each other in real time. For example, a case where the subject is a teacher and the user is a student, or a case where the subject is a physician and the user is a patient can be assumed.

### (5-4. Others)

For example, a free viewpoint video of a sport or the like can be generated on the basis of the 3D models of the plurality of subjects generated in the present embodiment, or an individual can distribute himself/herself, which is a 3D model generated in the present embodiment, to a distribution platform. As described above, the contents in the embodiments described in the present description can be applied to various technologies and services.

Furthermore, for example, the above-described programs may be executed in any device. In this case, the device is only required to have a necessary functional block and obtain necessary information.

Moreover, for example, each step of one flowchart may be executed by one device, or may be shared and executed by a plurality of devices. Moreover, in a case where a plurality of pieces of processing is included in one step, the plurality of pieces of processing may be executed by one device, or may be shared and executed by a plurality of devices. In other words, the plurality of pieces of processing included in one step can also be executed as pieces of processing of a plurality of steps. Conversely, the processing described as a plurality of steps can also be collectively executed as a single step.

Furthermore, for example, in a program executed by the computer, processing of steps describing the program may be executed in a time-series order in the order described in the present specification, or may be executed in parallel or individually at a required timing such as when a call is made. That is, the pieces of processing of the respective steps may be executed in an order different from the above-described order as long as there is no contradiction. Moreover, the processing of steps for describing the program may be executed in parallel with processing of another program, or may be executed in combination with processing of another program.

Moreover, for example, a plurality of techniques related to the present disclosure can be each independently implemented alone as long as there is no contradiction. Of course, any plurality of the present disclosures can be implemented in combination. For example, some or all of the present disclosure described in any of the embodiments can be implemented in combination with some or all of the present disclosure described in other embodiments. Furthermore, some or all of the above-described arbitrary present disclosure can be implemented in combination with other techniques not described above.

Note that the present disclosure can also have the following configurations.
<1> An information processing system including:
a virtual viewpoint image generation unit that generates a virtual viewpoint image by synthesizing multi-viewpoint images on the basis of a color synthesis weight set for each of the multi-viewpoint images according to a virtual viewpoint position;
a failure region acquisition unit that receives an input of a failure region designated by a user as a region in which a failure occurs in the virtual viewpoint image;
a re-synthesis unit that receives a correction input of the color synthesis weight of the failure region in each of the multi-viewpoint images used for synthesis of the virtual viewpoint image, corrects the color synthesis weight to a plurality of the color synthesis weights based on the correction input, and re-synthesizes a plurality of the virtual viewpoint images as a correction candidate image on the basis of the plurality of color synthesis weights; and
a correction information determination unit that receives selection information of the correction candidate image selected from a plurality of the correction candidate images as the failure is regarded as being corrected, and on the basis of the selection information, determines the color synthesis weights applied to the selected correction candidate image as correction information for correcting the failure.
<2> The information processing system according to <1>, further including
a color synthesis weight visualization unit that generates weight visualization information visualizing a magnitude of the color synthesis weight of the failure region in each of the multi-viewpoint images used for synthesis of the virtual viewpoint image,
in which the re-synthesis unit receives a correction input, using the weight visualization information, of the color synthesis weight of the failure region in each of the multi-viewpoint images used for synthesis of the virtual viewpoint image.
<3> The information processing system according to <2>, in which
the color synthesis weight visualization unit generates a weight map visualizing a magnitude of the color synthesis weight of the failure region in each of the multi-viewpoint images used for synthesis of the virtual viewpoint image, and
the re-synthesis unit receives a correction input, using the weight map, of the color synthesis weight of the failure region in each of the multi-viewpoint images used for synthesis of the virtual viewpoint image.
<4> The information processing system according to <3>, in which
the color synthesis weight visualization unit generates the weight map visualized with at least one of a color and a pattern according to a magnitude of the color synthesis weight of the failure region, and
the re-synthesis unit receives a correction input associated with correction of at least one of the color and the pattern of the weight map.
<5> The information processing system according to <2>, in which
the color synthesis weight visualization unit visualizes, with a slidack, a magnitude of the color synthesis weight of the failure region in each of the multi-viewpoint images used for synthesis of the virtual viewpoint image, and
the re-synthesis unit receives a correction input, using the slidack, of the color synthesis weight of the failure region in each of the multi-viewpoint images used for synthesis of the virtual viewpoint image.
<6> The information processing system according to <1>, further including
a correction information propagation unit that stores the correction information determined by the correction information determination unit,
in which when the correction information is stored in the correction information propagation unit, the virtual viewpoint image generation unit generates a virtual viewpoint image by synthesizing the multi-viewpoint images using the color synthesis weights as the correction information.
<7> The information processing system according to <1>, in which
the multi-viewpoint images are generated on the basis of a shape and texture data of a three-dimensional model, and
the virtual viewpoint image generation unit performs tracking of a position of a subject in the failure region in which the correction input is made on the basis of the shape and the texture data of the three-dimensional model supplied in time series to generate the multi-viewpoint images, and generates a virtual viewpoint image by synthesizing the multi-viewpoint images using the color synthesis weights as the correction information according to a tracked position of the subject.
<8> The information processing system according to <7>, in which
the virtual viewpoint image generation unit specifies a type of the failure according to the tracked position of the subject, and generates a virtual viewpoint image by synthesizing the multi-viewpoint images using the color synthesis weights as the correction information according to the type of the failure.
<9> The information processing system according to <8>, in which
the type of the failure includes a failure caused by low quality of the multi-viewpoint images having the large color synthesis weights, a failure in which a background is reflected in a portion of a foreground, and a failure in which a foreground is reflected in a portion of a background.
<10> The information processing system according to <7>, in which
the tracking includes Mesh-tracking.
<11> The information processing system according to <7>, further including
a correction case learning unit that acquires the shape and the texture data of the three-dimensional model and the correction information as correction cases, and learns learning information for realizing detecting a failure region of a virtual viewpoint image generated by synthesizing multi-viewpoint images generated from the shape and texture data of the three-dimensional model and correction of the detected failure region by learning using the correction cases.
<12> The information processing system according to <11>, further including
a learning correction unit that detects the failure region on the basis of the learning information for a virtual viewpoint image generated by synthesizing the multi-viewpoint images and generated by the virtual viewpoint image generation unit, and corrects the detected failure region.
<13> The information processing system according to <1>, further including
a quality improvement unit that improves quality of the multi-viewpoint images when the multi-viewpoint images used to generate the virtual viewpoint image have quality lower than a predetermined level of quality.
<14> An operation method of an information processing system, the operation method including the steps of:
generating a virtual viewpoint image by synthesizing multi-viewpoint images on the basis of a color synthesis weight set for each of the multi-viewpoint images according to a virtual viewpoint position;
receiving an input of a failure region designated by a user as a region in which a failure occurs in the virtual viewpoint image;
receiving a correction input of the color synthesis weight of the failure region in each of the multi-viewpoint images used for synthesis of the virtual viewpoint image, correcting the color synthesis weight to a plurality of the color synthesis weights based on the correction input, and re-synthesizing a plurality of the virtual viewpoint images as a correction candidate image on the basis of the plurality of color synthesis weights; and
receiving selection information of the correction candidate image selected from a plurality of the correction candidate images as the failure is regarded as being corrected, and on the basis of the selection information, determining the color synthesis weights applied to the selected correction candidate image as correction information for correcting the failure.
<15> A program for causing a computer to function as:
a virtual viewpoint image generation unit that generates a virtual viewpoint image by synthesizing multi-viewpoint images on the basis of a color synthesis weight set for each of the multi-viewpoint images according to a virtual viewpoint position;
a failure region acquisition unit that receives an input of a failure region designated by a user as a region in which a failure occurs in the virtual viewpoint image;
a re-synthesis unit that receives a correction input of the color synthesis weight of the failure region in each of the multi-viewpoint images used for synthesis of the virtual viewpoint image, corrects the color synthesis weight to a plurality of the color synthesis weights based on the correction input, and re-synthesizes a plurality of the virtual viewpoint images as a correction candidate image on the basis of the plurality of color synthesis weights; and
a correction information determination unit that receives selection information of the correction candidate image selected from a plurality of the correction candidate images as the failure is regarded as being corrected, and on the basis of the selection information, determines the color synthesis weights applied to the selected correction candidate image as correction information for correcting the failure.

### REFERENCE SIGNS LIST

101 Information processing system
111 Data acquisition unit
112 3D model generation unit
113 Encoding unit
114 Transmission unit
115 Reception unit
116 Decoding unit
117, 117′ Rendering unit
118 Display unit
121, 121-1 to 121-n Imaging device
151, 151′ Three-dimensional image synthesis unit
152 Display image generation unit
153, 153′ Three-dimensional image correction unit
154 Correction information propagation unit
171 Color synthesis weight calculation unit
172 Image synthesis unit
190 Image quality adjustment unit
191 Failure region information acquisition unit
192, 192′ Color synthesis weight visualization unit
193 Color synthesis weight correction information acquisition unit
194 Candidate image re-synthesis unit
195 Correction information determination unit
196 UI image generation unit
211 Correction case learning unit
212 Case information DB
221 Correction case acquisition unit
222 Learning unit
223 Learning information transmission unit
231 Learning correction unit

1. An information processing system comprising:
a virtual viewpoint image generation unit that generates a virtual viewpoint image by synthesizing multi-viewpoint images on a basis of a color synthesis weight set for each of the multi-viewpoint images according to a virtual viewpoint position;
a failure region acquisition unit that receives an input of a failure region designated by a user as a region in which a failure occurs in the virtual viewpoint image;
a re-synthesis unit that receives a correction input of the color synthesis weight of the failure region in each of the multi-viewpoint images used for synthesis of the virtual viewpoint image, corrects the color synthesis weight to a plurality of the color synthesis weights based on the correction input, and re-synthesizes a plurality of the virtual viewpoint images as a correction candidate image on a basis of the plurality of color synthesis weights; and
a correction information determination unit that receives selection information of the correction candidate image selected from a plurality of the correction candidate images as the failure is regarded as being corrected, and on a basis of the selection information, determines the color synthesis weights applied to the selected correction candidate image as correction information for correcting the failure.

2. The information processing system according to claim 1, further comprising
a color synthesis weight visualization unit that generates weight visualization information visualizing a magnitude of the color synthesis weight of the failure region in each of the multi-viewpoint images used for synthesis of the virtual viewpoint image,
wherein the re-synthesis unit receives a correction input, using the weight visualization information, of the color synthesis weight of the failure region in each of the multi-viewpoint images used for synthesis of the virtual viewpoint image.

3. The information processing system according to claim 2, wherein
the color synthesis weight visualization unit generates a weight map visualizing a magnitude of the color synthesis weight of the failure region in each of the multi-viewpoint images used for synthesis of the virtual viewpoint image, and
the re-synthesis unit receives a correction input, using the weight map, of the color synthesis weight of the failure region in each of the multi-viewpoint images used for synthesis of the virtual viewpoint image.

4. The information processing system according to claim 3, wherein
the color synthesis weight visualization unit generates the weight map visualized with at least one of a color and a pattern according to a magnitude of the color synthesis weight of the failure region, and
the re-synthesis unit receives a correction input associated with correction of at least one of the color and the pattern of the weight map.

5. The information processing system according to claim 2, wherein
the color synthesis weight visualization unit visualizes, with a slidack, a magnitude of the color synthesis weight of the failure region in each of the multi-viewpoint images used for synthesis of the virtual viewpoint image, and
the re-synthesis unit receives a correction input, using the slidack, of the color synthesis weight of the failure region in each of the multi-viewpoint images used for synthesis of the virtual viewpoint image.

6. The information processing system according to claim 1, further comprising
a correction information propagation unit that stores the correction information determined by the correction information determination unit,
wherein when the correction information is stored in the correction information propagation unit, the virtual viewpoint image generation unit generates a virtual viewpoint image by synthesizing the multi-viewpoint images using the color synthesis weights as the correction information.

7. The information processing system according to claim 1, wherein
the multi-viewpoint images are generated on a basis of a shape and texture data of a three-dimensional model, and
the virtual viewpoint image generation unit performs, to generate a virtual viewpoint image in time series, tracking of a position of a subject in the failure region in which the correction input is made on a basis of the shape and the texture data of the three-dimensional model supplied in time series to generate the multi-viewpoint images, and generates a virtual viewpoint image by synthesizing the multi-viewpoint images using the color synthesis weights as the correction information according to a tracked position of the subject.

8. The information processing system according to claim 7, wherein
the virtual viewpoint image generation unit specifies a type of the failure according to the tracked position of the subject, and generates a virtual viewpoint image by synthesizing the multi-viewpoint images using the color synthesis weights as the correction information according to the type of the failure.

9. The information processing system according to claim 8, wherein
the type of the failure includes a failure caused by low quality of the multi-viewpoint images having the large color synthesis weights, a failure in which a background is reflected in a portion of a foreground, and a failure in which a foreground is reflected in a portion of a background.

10. The information processing system according to claim 7, wherein
the tracking includes Mesh-tracking.

11. The information processing system according to claim 7, further comprising
a correction case learning unit that acquires the shape and the texture data of the three-dimensional model and the correction information as correction cases, and learns learning information for realizing detecting a failure region of a virtual viewpoint image generated by synthesizing multi-viewpoint images generated from the shape and texture data of the three-dimensional model and correction of the detected failure region by learning using the correction cases.

12. The information processing system according to claim 11, further comprising
a learning correction unit that detects the failure region on a basis of the learning information for a virtual viewpoint image generated by synthesizing the multi-viewpoint images and generated by the virtual viewpoint image generation unit, and corrects the detected failure region.

13. The information processing system according to claim 1, further comprising
a quality improvement unit that improves quality of the multi-viewpoint images when the multi-viewpoint images used to generate the virtual viewpoint image have quality lower than a predetermined level of quality.

14. An operation method of an information processing system, the operation method comprising the steps of:
generating a virtual viewpoint image by synthesizing multi-viewpoint images on a basis of a color synthesis weight set for each of the multi-viewpoint images according to a virtual viewpoint position;
receiving an input of a failure region designated by a user as a region in which a failure occurs in the virtual viewpoint image;
receiving a correction input of the color synthesis weight of the failure region in each of the multi-viewpoint images used for synthesis of the virtual viewpoint image, correcting the color synthesis weight to a plurality of the color synthesis weights based on the correction input, and re-synthesizing a plurality of the virtual viewpoint images as a correction candidate image on a basis of the plurality of color synthesis weights; and
receiving selection information of the correction candidate image selected from a plurality of the correction candidate images as the failure is regarded as being corrected, and on a basis of the selection information, determining the color synthesis weights applied to the selected correction candidate image as correction information for correcting the failure.

15. A program for causing a computer to function as:
a virtual viewpoint image generation unit that generates a virtual viewpoint image by synthesizing multi-viewpoint images on a basis of a color synthesis weight set for each of the multi-viewpoint images according to a virtual viewpoint position;
a failure region acquisition unit that receives an input of a failure region designated by a user as a region in which a failure occurs in the virtual viewpoint image;
a re-synthesis unit that receives a correction input of the color synthesis weight of the failure region in each of the multi-viewpoint images used for synthesis of the virtual viewpoint image, corrects the color synthesis weight to a plurality of the color synthesis weights based on the correction input, and re-synthesizes a plurality of the virtual viewpoint images as a correction candidate image on a basis of the plurality of color synthesis weights; and
a correction information determination unit that receives selection information of the correction candidate image selected from a plurality of the correction candidate images as the failure is regarded as being corrected, and on a basis of the selection information, determines the color synthesis weights applied to the selected correction candidate image as correction information for correcting the failure.
